(19) United States
(12) Patent Application Publication
(10) Pub. No.: US 2022/0172720 A1
(43) Pub. Date: Jun. 2, 2022

(54) INFORMATION PROCESSING DEVICE AND INFORMATION PROCESSING METHOD

(71) Applicant: SONY GROUP CORPORATION, TOKYO (JP)

(72) Inventors: KEISUKE TOUYAMA, TOKYO (JP); SHINTARO MASUI, KANAGAWA (JP); NAOKI SHIBUYA, TOKYO (JP)

(21) Appl. No.: 17/594,056

(22) PCT Filed: Jan. 23, 2020
(86) PCT No.: PCT/JP2020/002272

§ 371 Date: Sep. 30, 2021

(30) Foreign Application Priority Data
Apr. 12, 2019 (JP) 2019-076699

(51) Int. Cl. G10L 15/22; G06F 3/16; G06F 3/14

(52) U.S. Cl. CPC G10L 15/22; G10L 15/1815; G06F 3/14; G06F 3/165

(57) ABSTRACT

An information processing device (1) includes: an acquisition unit (134) that acquires constraint information indicating a constraint based on an output format of information; and a provision unit (135) that provides information regarding a song selection reason of a song output in the output format on the basis of the constraint information acquired by the acquisition unit (134).

### FIELD

The present disclosure relates to an information processing device and an information processing method.

### BACKGROUND

There are applications for music reproduction as one type of applications used in a device such as a smart speaker supporting interactive voice operation. By such an application, the song content such as a singer name or a song name is automatically reproduced in accordance with designation from a user. In addition, in a case where there is no designation of a singer name or the like, such an application can automatically reproduce and provide, to the user, the song content or the like that is recommendable.

Here, proposed is technology aiming at presenting a reason for automatically reproducing recommended song content in a device such as a smart speaker. For example, a method is known which presents a feature amount used at the time of matching a search query that has been input and the song content, and also known is a method of selecting a song on the basis of a location where the user selects songs and spot information and presenting the reason of the selection at the time of reproduction.

### CITATION LIST

### Patent Literature

Patent Literature 1: JP 2015-32186 A

Patent Literature 2: JP 2006-293697 A

### SUMMARY

### Technical Problem

In a case where the song selection reason of recommended song content is conveyed to a user as in the conventional technology described above, it is difficult to convey the reason without hindering the flow in which the user enjoys the music.

Therefore, the present disclosure proposes an information processing device and an information processing method capable of conveying, to a user, a song selection reason of the song content without hindering a flow in which the user enjoys the music.

### Solution to Problem

To solve the above problem, an information processing device according to an embodiment of the present disclosure includes: an acquisition unit that acquires constraint information indicating a constraint based on an output format of information; and a provision unit that provides information regarding a song selection reason of a song output in the output format on a basis of the constraint information acquired by the acquisition unit.

### BRIEF DESCRIPTION OF DRAWINGS

FIG. 1 is a diagram illustrating a configuration example of an information processing device according to a first embodiment of the present disclosure.

FIG. 2 is a table illustrating an example of information stored in a user basic information storing unit of the present disclosure.

FIG. 3 is a table illustrating an example of information stored in a song selection history storing unit of the present disclosure.

FIG. 4 is a table illustrating an example of selection reason output rules stored in a selection reason output rule storing unit of the present disclosure.

FIG. 5 is a diagram illustrating an exemplary process by a sensor input analyzing unit of the present disclosure.

FIG. 6 is a diagram illustrating an exemplary process by a selection unit of the present disclosure.

FIG. 7 is a diagram illustrating the concept of a process by a selection unit of the present disclosure.

FIG. 8 includes diagrams illustrating an example of updating a song selection history stored in the song selection history storing unit of the present disclosure.

FIG. 9 is a diagram illustrating an exemplary process by an acquisition unit of the present disclosure.

FIG. 10 is a diagram illustrating an example of an analysis result of the song content of the present disclosure.

FIG. 11 is a diagram illustrating an example of an analysis result of the song content of the present disclosure.

FIG. 12 is a diagram illustrating an example of an analysis result of the song content of the present disclosure.

FIG. 13 is a diagram illustrating an exemplary process by a provision unit of the present disclosure.

FIG. 14 is a table illustrating an example of a song selection reasoning sentence provided by the provision unit of the present disclosure.

FIG. 15 is a table illustrating an example of a song selection reasoning sentence provided by the provision unit of the present disclosure.

FIG. 16 is a table illustrating an example of a song selection reasoning sentence provided by the provision unit of the present disclosure.

FIG. 17 is a table illustrating an example of a song selection reasoning sentence provided by the provision unit of the present disclosure.

FIG. 18 is a table illustrating an example of a song selection reasoning sentence provided by the provision unit of the present disclosure.

FIG. 19 is a table illustrating an example of a song selection reasoning sentence provided by the provision unit of the present disclosure.

FIG. 20 is a table illustrating an example of a song selection reasoning sentence provided by the provision unit of the present disclosure.

FIG. 21 is a table illustrating an example of a song selection reasoning sentence provided by the provision unit of the present disclosure.

FIG. 22 is a table illustrating an example of a song selection reasoning sentence provided by the provision unit of the present disclosure.

FIG. 23 is a flowchart illustrating a procedure of processes of the information processing device according to the first embodiment of the present disclosure.

FIG. 24 is a diagram illustrating an outline of processes according to a modification of the first embodiment of the present disclosure.

FIG. 25 is a diagram illustrating an exemplary process of a provision unit according to a second embodiment of the present disclosure.

FIG. 26 is a table illustrating exemplary changes in an analysis result of sensor input according to the second embodiment of the present disclosure.

FIG. 27 is a diagram illustrating exemplary changes in the behavior and the situation of a user according to the second embodiment of the present disclosure.

FIG. 28 is a diagram illustrating an example of a song selection reasoning sentence corresponding to FIG. 26 of the present disclosure.

FIG. 29 is a diagram illustrating other exemplary changes in the behavior and the situation of a user according to the second embodiment of the present disclosure.

FIG. 30 is a diagram illustrating an example of a song selection reasoning sentence corresponding to FIG. 28 of the present disclosure.

FIG. 31 is a flowchart illustrating a procedure of processes of an information processing device according to the second embodiment of the present disclosure.

FIG. 32 is a diagram illustrating a display example of a song selection reason according to another embodiment of the present disclosure.

FIG. 33 is a hardware configuration diagram illustrating an example of a computer that implements functions of an information processing device of the present disclosure.

### DESCRIPTION OF EMBODIMENTS

Hereinafter, embodiments of the present disclosure will be described in detail by referring to the drawings. Note that, in the following embodiments, there are cases where redundant description is omitted by denoting the same parts by a same reference numeral.

In addition, the present disclosure will be described in the following order of items.

1. First Embodiment

1-1. Configuration of Information Processing Device According to First Embodiment

1-2. Exemplary Processes of Information Processing Device According to First Embodiment

1-3. Procedure of Processes of Information Processing Device According to First Embodiment

1-4. Modification of First Embodiment

2. Second Embodiment

2-1. Exemplary Processes of Information Processing Device According to Second Embodiment

2-2. Procedure of Processes of Information Processing Device According to Second Embodiment

2-3. Modification of Second Embodiment

3. Other Embodiments

4. Effects of Information Processing Device According to Present Disclosure

5. Hardware Configuration

### 1. FIRST EMBODIMENT

[1-1. Configuration of Information Processing Device According to First Embodiment]

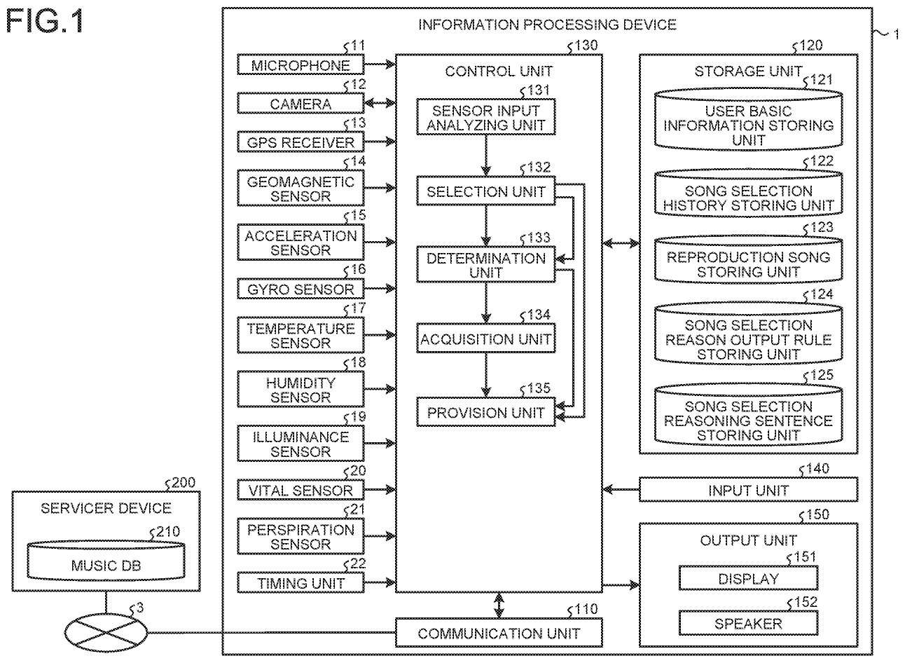

FIG. 1 is a diagram illustrating a configuration example of an information processing device 1 according to a first embodiment of the present disclosure. The information processing device 1 illustrated in FIG. 1 is, for example, a device such as a smart speaker supporting interactive voice operation. Processes executed by such an information processing device 1 includes a process of automatically reproducing the song content corresponding to a received singer name, a song name, or the like when designation of the singer name, the song name, or the like has been received from a user (hereinafter, referred to as a “user”) of the information processing device 1 by voice input. The outline of the information processing device 1 is to provide a song selection reason of the song content when the song content is reproduced and provided to the user.

The information processing device 1 illustrated in FIG. 1 includes a microphone 11, a camera 12, a GPS receiver 13, a geomagnetic sensor 14, an acceleration sensor 15, a gyro sensor 16, a temperature sensor 17, a humidity sensor 18, an illuminance sensor 19, a vital sensor 20, a perspiration sensor 21, and a timing unit 22. The information processing device 1 illustrated in FIG. 1 further includes a communication unit 110, a storage unit 120, a control unit 130, an input unit 140, and an output unit 150. The microphone 11, the camera 12, the GPS receiver 13, the geomagnetic sensor 14, the acceleration sensor 15, the gyro sensor 16, the temperature sensor 17, the humidity sensor 18, the illuminance sensor 19, the vital sensor 20, and the perspiration sensor 21 are examples of a detection unit.

The communication unit 110 is an interface such as a network interface card (NIC) that communicates with a servicer device 200 communicably connected to a communication network 3. Examples of the communication network 3 include a wide area network (WAN) such as the Internet. The communication unit 110 transmits and receives data such as the song content from the servicer device 200. The connection form of the communication network 3 may be wireless or wired.

The information processing device 1 acquires the song content stored in a music DB 210 included in the servicer device 200 from the servicer device 200 via the communication unit 110. The servicer device 200 includes the music DB 210 in which data of the song content is accumulated. The servicer device 200 provides, to the information processing device 1, an application program interface (API) for accessing the servicer device 200. The servicer device 200 provides the song content stored in the music DB 210 to the information processing device 1 connected through the API. The information processing device 1 may not only sequentially acquire desired content of a song from the servicer device 200 but may also, to some extent, collectively and periodically perform the acquisition and manage, in a local environment, the song contents that have been acquired. Furthermore, the information processing device 1 is not limited to the case of managing the song content itself in the local environment and may also manage a content list, metadata of the song contents, song IDs, and the like in the local environment. Note that the information processing device 1 may be mounted with a database itself that accumulates the song content that corresponds to the music DB 210.

The storage unit 120 includes a user basic information storing unit 121, a song selection history storing unit 122, a reproduction song storing unit 123, a song selection reason output rule storing unit 124, and a song selection reasoning sentence storing unit 125. The storage unit 120 is implemented by, for example, a semiconductor memory element such as a random access memory (RAM) or a flash memory or a storage device such as a hard disk or an optical disk.

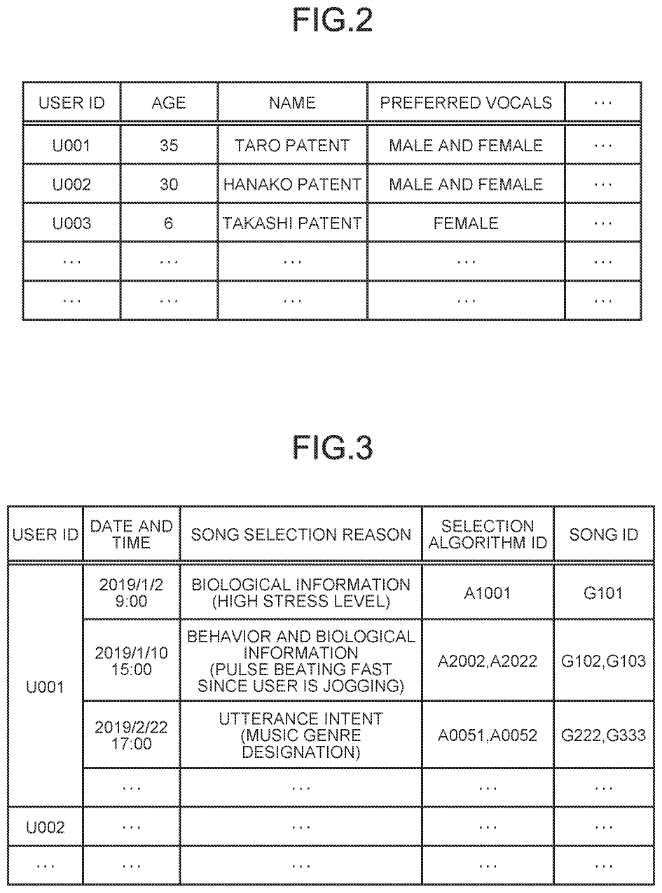

The user basic information storing unit 121 stores user basic information. FIG. 2 is a table illustrating an example of information stored in the user basic information storing unit 121 of the present disclosure. As illustrated in FIG. 2, the user basic information stored in the user basic information storing unit 121 includes items such as a user ID, age, and a name, and these items are associated with each other. In the item of user ID, identification information uniquely provided to a user is stored. In the item of age, information of the age of the user is stored. In the item of name, information of the name of the user is stored. Note that the information stored in the item of name may be not only the real name of the user but may also be various types of information such as a handle name or initials.

The song selection history storing unit 122 stores a song selection history. FIG. 3 is a table illustrating an example of information stored in the song selection history storing unit 122 of the present disclosure. As illustrated in FIG. 3, the song selection history stored in the song selection history storing unit 122 includes items of user ID, date and time, algorithm ID, song selection reason, and song ID, and these items are associated with each other. In the item of user ID, identification information uniquely assigned to a user is stored. In the item of date and time, information of date and time for specifying the date and time when the song has been selected is stored. In the item of algorithm ID, identification information uniquely assigned to a song selection algorithm is stored. In the item of song selection reason, information of the song selection reason of a song provided to a user is stored. In the item of song ID, identification information uniquely assigned to the song content is stored.

The reproduction song storing unit 123 stores the song content that has been selected to be provided to a user. Note that the reproduction song storing unit 123 is not limited to the case of storing the song content itself and also may store identification information of the song content such as the song ID. When reproducing the song content, the information processing device 1 acquires the song content from the servicer device 200 on the basis of the information such as the song ID that is stored in the reproduction song storing unit 123. Note that the information processing device 1 is not limited to the case of reproducing after acquiring the song content of the servicer device 200 and may perform streaming reproduction.

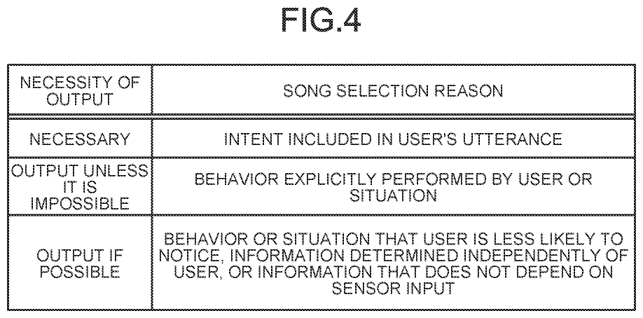

The song selection reason output rule storing unit 124 stores a song selection reason output rule for outputting a song selection reason to be provided to a user from a plurality of song selection reasons. FIG. 4 is a table illustrating an example of selection reason output rules stored in the song selection reason output rule storing unit 124 of the present disclosure. The selection reason output rules illustrated in FIG. 4 includes the item of necessity of output and the item of song selection reason, and these items are associated with each other. In the item of necessity of output, the degree (importance) to which the output of a song selection reason is required is stored. In the item of song selection reason, information of the song selection reason is stored.

According to the selection reason output rules illustrated in FIG. 4, the necessity (importance) of output (provision to the user) is larger as the user is more clearly aware of a song selection reason. For example, in a case where the intent included in a user's utterance such as an artist name or a song name that the user wishes to reproduce is the song selection reason, necessity of output is defined as that the output is necessary. The intent included in the user's utterance can be determined as a song selection reason having the highest importance and is a matter that should be selected as the song selection reason to be provided to the user with the highest priority.

In addition, according to the song selection reason output rules illustrated in FIG. 4, in a case where the behavior explicitly performed by the user or the situation is the song selection reason, the necessity of output is defined as requiring output unless it is impossible. The behavior explicitly performed by the user or the situation includes jogging, traveling, cleaning, being with a specific person, and the like. The behavior explicitly performed by the user or the situation can be determined to be a song selection reason having relatively high importance and is a matter to be selected as the song selection reason to be provided to the user following the intent included in the user's utterance.

Furthermore, according to the selection reason output rules illustrated in FIG. 4, in a case where information determined independently of the user or the user's behavior or situation that the user is less likely to notice or information that does not depend on sensor input is the song selection reason, the necessity of output is defined as requiring output if possible. The user's behavior or the situation that the user is less likely to notice include, for example, biological information such as a pulse. The information determined independently of the user includes external information such as date and time or the weather. The information that does not depend on sensor input includes artist's promotion information and the like. Information determined independently of the user or the user's behavior or situation that the user is less likely to notice or information that does not depend on sensor input is relatively less important than the intent included in a user's utterance or the behavior explicitly performed by the user or the situation. Therefore, such information is a matter that should be selected as the song selection reason to be provided to the user after the intent included in a user's utterance or the behavior explicitly performed by the user or the situation.

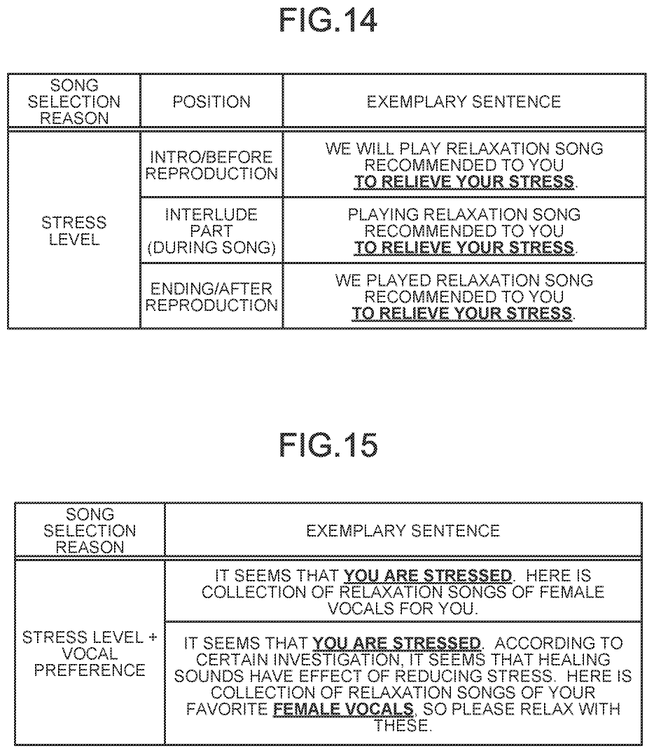

The song selection reasoning sentence storing unit 125 stores information of a song selection reasoning sentence for providing the user with the song selection reason of the song content. The information of the song selection reasoning sentence contains a plurality of fixed phrases which has different lengths and is created in advance by a system administrator or the like for various assumed song selection reasons. As will be described later, the song selection reasoning sentence includes a sentence containing at least one song selection reason (FIGS. 14 to 22). Examples of a song selection reason include an intent included in the user's utterance, the behavior explicitly performed by the user or the situation, the behavior or the situation that the user is less likely to notice, and information determined independently of the user. Examples of the intent included in the user's utterance include information such as an artist name, a song name, and a music genre which are desired to be reproduced. Examples of the behavior explicitly performed by the user include jogging, cleaning, dining, and traveling. Examples of the behavior or a situation that the user is less likely to notice include biological information such as the pulse (heart rate) or the blood pressure. Examples of the information determined independently of the user include external information such as the date and time or the weather. Furthermore, examples of the information determined independently of the user include information such as the order of new arrival or the order of sales of the song content acquired from a determination unit 133.

It is also possible to include information that does not depend on sensor input as one of the categories of the song selection reason to be included in a song selection reasoning sentence stored in the song selection reasoning sentence storing unit 125. Examples of the information that does not depend on sensor input include artist's promotion information provided from the music DB 210.

In addition, the song selection history of the user stored in the song selection history storing unit 122 can be included as one of the categories of the song selection reason to be included in a song selection reasoning sentence stored in the song selection reasoning sentence storing unit 125.

The control unit 130 is implemented by, for example, a central processing unit (CPU), a micro processing unit (MPU), or the like executing various programs stored in a storage device inside the information processing device 1 using the RAM as a work area. Furthermore, the control unit 130 is implemented by, for example, an integrated circuit such as an application specific integrated circuit (ASIC) or a field programmable gate array (FPGA).

The control unit 130 includes a sensor input analyzing unit 131, a selection unit 132, a determination unit 133, an acquisition unit 134, and a provision unit 135. The information processing device 1 having such a configuration implements or executes functions or effects of information processing described below. Note that the configuration of the information processing device 1 does not need to be particularly limited to the example illustrated in FIG. 1 and may be another configuration as long as the configuration implements or executes the information processing described below.

The information processing device 1 having such a configuration executes processes of analysis of sensor input, selection of a song selection algorithm, acquisition of the song content, determination of the reproduction order, analysis of the song content, generation of a song selection reasoning sentence, and superimposition of song selection reasons. Hereinafter, these processes will be described by referring to the drawings.

[1-2. Exemplary Processes of Information Processing Device According to First Embodiment]

Each of the processes of analysis of sensor input, selection of a song selection algorithm, acquisition of the song content, determination of the reproduction order, analysis of the song content, selection of a song selection reasoning sentence, and superimposition of song selection reasons by the information processing device 1 illustrated in FIG. 1 will be described by referring to the drawings.

(Sensor Input Analyzing Process)

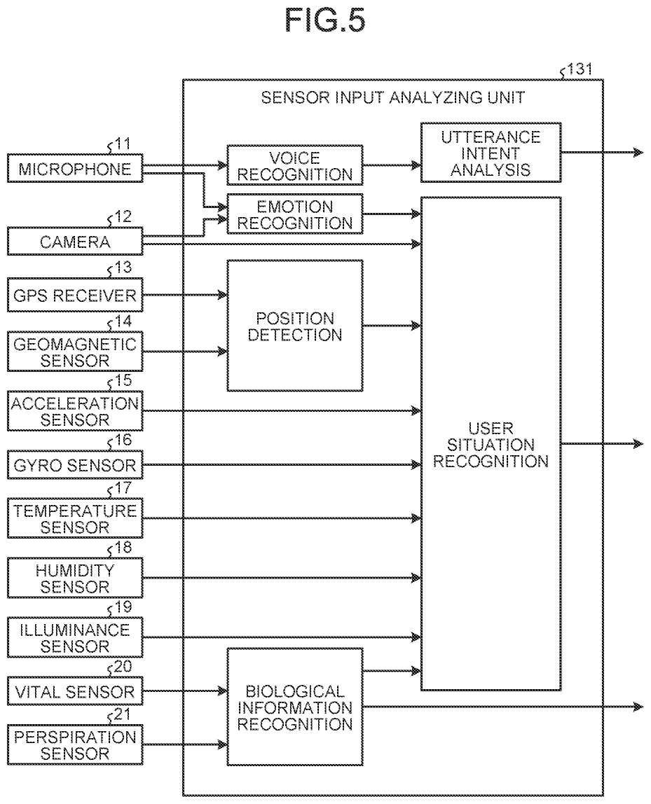

An exemplary process by the sensor input analyzing unit 131 will be described by referring to FIG. 5. FIG. 5 is a diagram illustrating an exemplary process by the sensor input analyzing unit 131 of the present disclosure. The sensor input analyzing unit 131 is an example of a detection result analyzing unit.

As illustrated in FIG. 5, the sensor input analyzing unit 131 analyzes a detection result of information regarding the user, that is, input from the microphone 11, the camera 12, and various sensors. The analysis result by the sensor input analyzing unit 131 includes an intent included in the user's utterance, the behavior explicitly performed by the user or the situation, the behavior or the situation that the user is less likely to notice, and information determined independently of the user. Then, the sensor input analyzing unit 131 transmits the analysis result to the selection unit 132.

For example, the sensor input analyzing unit 131 recognizes the user's voice on the basis of a sound signal corresponding to the user's voice that is input from the microphone 11. Subsequently, the sensor input analyzing unit 131 analyzes the intent of utterance of the user by using the recognition result of the user's voice. An utterance intent analyzing unit 101b transmits the analysis result of the intent of the user's utterance to the selection unit 132.

The sensor input analyzing unit 131 also recognizes the user's emotions on the basis of a sound signal corresponding to the user's voice that is input from the microphone 11. Furthermore, the sensor input analyzing unit 131 recognizes the user's emotions on the basis of the user's image input from the camera 12. The sensor input analyzing unit 131 may recognize the user's emotions on the basis of both the user's voice and image.

Furthermore, the sensor input analyzing unit 131 acquires position information of the user on the basis of a signal indicating the position of the information processing device 1 input from the GPS receiver 13 and a measurement result of the azimuth of the information processing device 1 input from the geomagnetic sensor 14.

In addition, the sensor input analyzing unit 131 recognizes the biological information of the user on the basis of information of the pulse or the respiration rate input from the vital sensor 20 and information of the perspiration amount input from the perspiration sensor 21. The sensor input analyzing unit 131 transmits the recognition result of the biological information of the user to the selection unit 102. The sensor input analyzing unit 131 does not need to be particularly limited to the example of recognizing the biological information of the user on the basis of both sensor input from the vital sensor 20 and the perspiration sensor 21. For example, the sensor input analyzing unit 131 may recognize biological information of the basis of sensor input from either the vital sensor 20 or the perspiration sensor 21.

Furthermore, the sensor input analyzing unit 131 recognizes the user's behavior or the situation on the basis of a recognition result of the user's emotions, a detection result of the user's position, detection results of various sensors, and a recognition result of the biological information. The sensor input analyzing unit 131 can use detection results of the camera 12, the acceleration sensor 15, the gyro sensor 16, the temperature sensor 17, the humidity sensor 18, and the illuminance sensor 19 in order to recognize the user's behavior and the situation. The sensor input analyzing unit 131 transmits a recognition result regarding the user's behavior or the situation to the selection unit 102.

Furthermore, the sensor input analyzing unit 131 does not need to be particularly limited to an example of integrating sensor input from various sensors to recognize the user's behavior or the situation and may recognize the biological information on the basis of sensor input from a single sensor. Alternatively, the sensor input analyzing unit 131 may recognize the user's behavior or the situation by recording the user's behavior or the situation and comparing with the current state.

Furthermore, the sensor input analyzing unit 131 may acquire date and time information acquired by the timing unit 22, weather information acquired by communication via the communication unit 110, the age and the sex of the user of the information processing device 1 stored in the user basic information storing unit 121, and the like. In this case, the sensor input analyzing unit 131 can use externally acquired information such as date and time information and weather information and demographic information such as the age and the sex of the user for recognizing the user's behavior or the situation.

(Song Selection Algorithm Selecting Process)

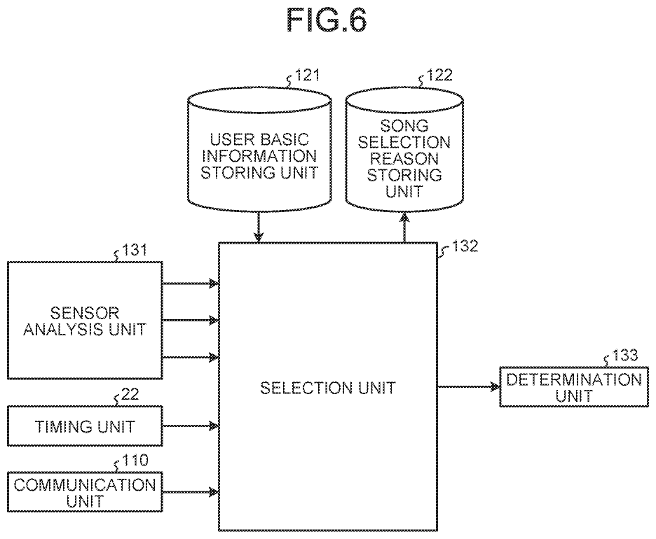

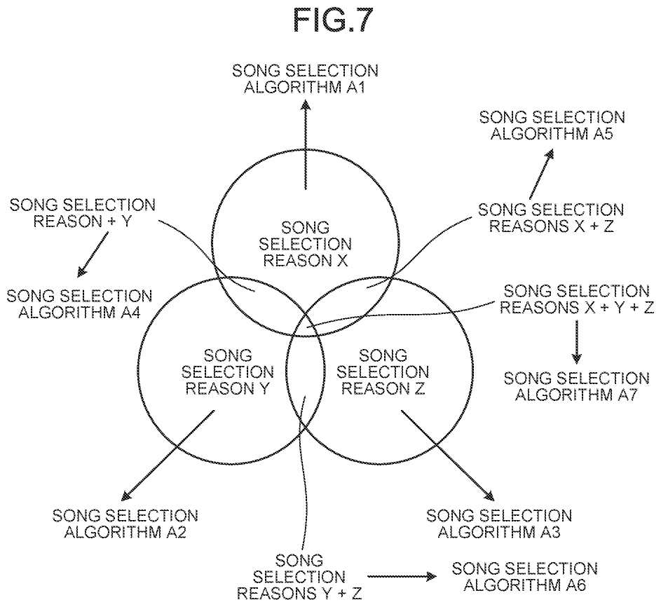

An exemplary process by the selection unit 132 of the present disclosure will be described by referring to FIG. 6. FIG. 7 is a diagram illustrating an exemplary process by the selection unit 132.

As illustrated in FIG. 6, the selection unit 132 selects an appropriate song selection algorithm from a plurality of song selection algorithms that has been created in advance depending on the analysis result by the sensor input analyzing unit 131. The selection unit 132 executes selection of a song selection algorithm by using, for example, voice input of a user who requests reproduction of a song as a trigger. The song selection algorithm is created in advance by, for example, the administrator of the information processing device 1.

FIG. 7 is a diagram illustrating the concept of a process by the selection unit 132 of the present disclosure. As illustrated in FIG. 7, the selection unit 132 can select, for example, song selection algorithms A1 to A7 corresponding to song selection reason X, song selection reason Y, song selection reason Z, song selection reasons X+Y, song selection reasons X+Z, song selection reasons Y+Z, and song selection reasons X+Y+Z, respectively. As a method of selecting a song selection algorithm by the selection unit 132, any method such as a method based on a selection policy set in advance can be adopted. Examples of the selection policy include a policy of selecting a song selection algorithm that matches all the song selection reasons or selecting a song selection algorithm that matches at least one of the song selection reasons. In the song selection algorithm selected by the selection unit 132, it is possible to select the song content that matches the user's request or the situation more as the number of overlaps of song selection reasons increases. Hereinafter, a specific example of song selection algorithms that match the song selection reason will be described.

The selection unit 132 selects a song selection algorithm of selecting the song content that matches the state of the body of the user on the basis of the recognition result of the biological information of the user. For example, when the selection unit 132 decides that the stress level of the user is high, “high stress level” is set as the song selection reason. Then, the selection unit 132 selects a song selection algorithm for searching and acquiring the song content that can lower the stress level from among a plurality of song selection algorithms.

Furthermore, the selection unit 132 selects a selection algorithm of selecting the song content that matches the current state of the user on the basis of the recognition result regarding the user's behavior or the situation and the position information. For example, when the selection unit 132 decides that the user is traveling in Hokkaido, “trip to Hokkaido” is set as the song selection reason. Then, the selection unit 132 selects a song selection algorithm for searching and acquiring the song content related to Hokkaido from the plurality of song selection algorithms. Examples of the song content related to Hokkaido include the song content of artists from Hokkaido and the song content used in a movie, a drama, or the like set in Hokkaido.

Furthermore, the selection unit 132 selects a song selection algorithm of selecting the song content that matches the behavior of the user on the basis of a recognition result of the user's behavior or the situation or recognition results of various types of sensor information, the position information, and the biological information. For example, when the selection unit 132 decides that the user is jogging and that the pulse is fast, “jogging and fast pulse” is set as the song selection reason. Then, the selection unit 132 selects a song selection algorithm for searching for and acquiring the song content that is likely to lower the pulse of the user who is jogging (that may possibly contribute to lowering the pulse) from among the plurality of song selection algorithms.

Alternatively, the selection unit 132 selects a song selection algorithm of selecting the song content matching the intent of the user's utterance on the basis of an analysis result of the intent of the user's utterance. For example, when the selection unit 132 decides that designation of the genre of a song is included in the intent of the user's utterance, “designation of the genre of a song is included in the intent of the user's utterance” is set as the song selection reason. Then, the selection unit 132 selects a song selection algorithm for searching and acquiring the song content of the genre designated by the user from the plurality of song selection algorithms.

The song selection algorithm selected by the selection unit 132 generates a search query for searching for and acquiring, from the music DB 210, the song content or a playlist to be selected. For example, the song selection algorithm selected by the selection unit 132 due to the song selection reason of “high stress level” generates a search query based on keywords such as “stress, healing sound, relaxation” that match the song selection reason.

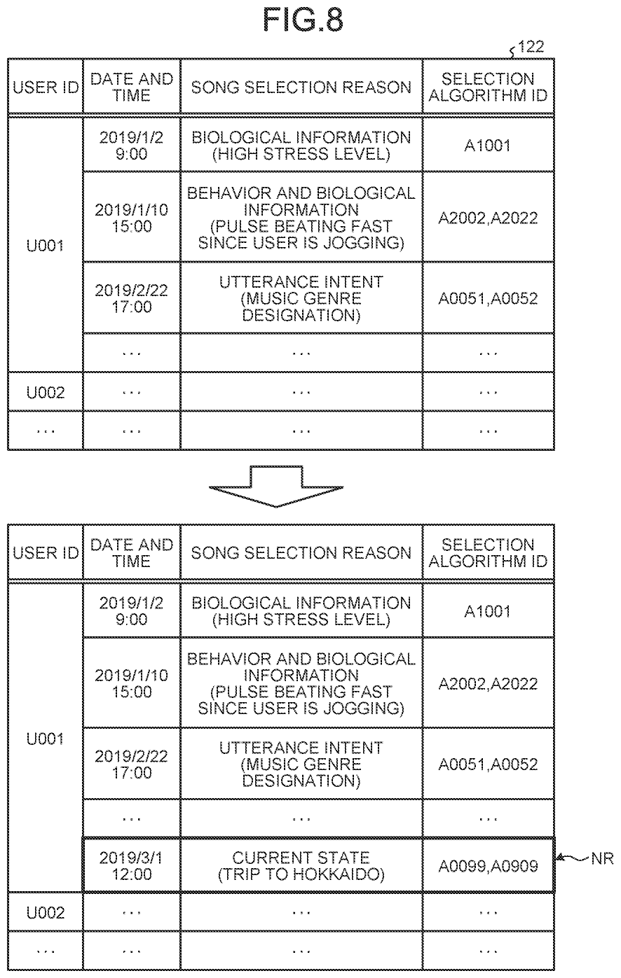

The selection unit 132 updates the song selection history stored in the song selection history storing unit 122. FIG. 8 includes diagrams illustrating an example of update of the song selection history stored in the song selection history storing unit 122 of the present disclosure. As illustrated in FIG. 8, when the selection unit 132 decides that the user is traveling in Hokkaido and selects a song selection algorithm for searching and acquiring the song content related to Hokkaido, a new record NR is stored in the song selection history storing unit 122.

Subsequently, the selection unit 132 searches the song content from the music DB 210 using the generated search query and acquires the searched the song content. The selection unit 132 registers information of the song ID of the acquired the song content in the song selection history storing unit 122.

Referring back to FIG. 1, in a case where there is a plurality of pieces of song content acquired by the selection unit 132, the determination unit 133 determines the reproduction order of the song content on the basis of a reproduction order determination algorithm. For example, the determination unit 133 determines the reproduction order on the basis of information such as the order of new arrival or the order of sales of the song content. Then, the determination unit 133 stores a plurality of pieces of song content in the reproduction song storing unit 123 in accordance with the determined reproduction order. Note that, in a case where a single piece of song content is acquired by the selection unit 132, the determination unit 133 stores the song content as it is in the reproduction song storing unit 123.

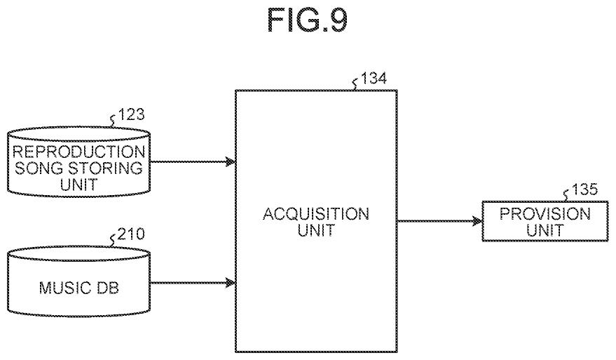

The acquisition unit 134 acquires constraint information indicating a constraint based on the output format of information. Specifically, the acquisition unit 134 analyzes the structure of the song content acquired by the selection unit 132. Then, at the time of reproduction of the song content, the acquisition unit 134 acquires, with respect to the song content, as the constraint information, the length of time of a superimposable portion on which information regarding the song selection reason that has been converted into voice can be superimposed. FIG. 9 is a diagram illustrating an exemplary process by the acquisition unit 134 of the present disclosure. As illustrated in FIG. 9, the acquisition unit 134 analyzes the structure of the song content on the basis of waveform data of the song content acquired by the selection unit 132 or metadata of the song content included in the music DB 210. As the metadata of the song content, for example, metadata provided from a servicer of the song content can be acquired.

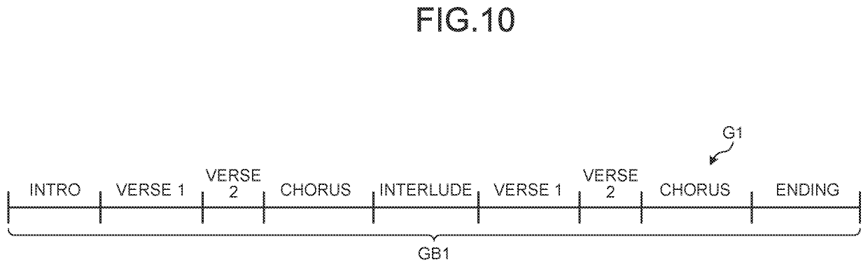

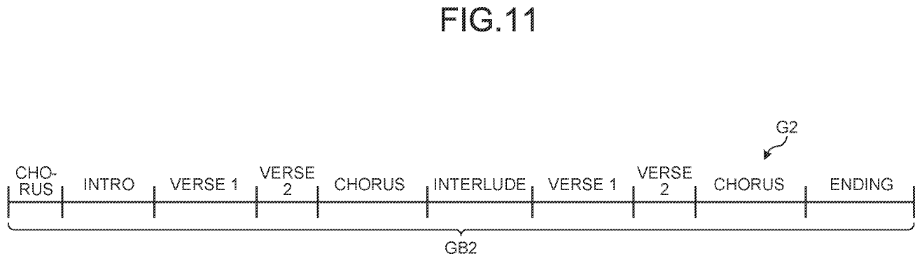

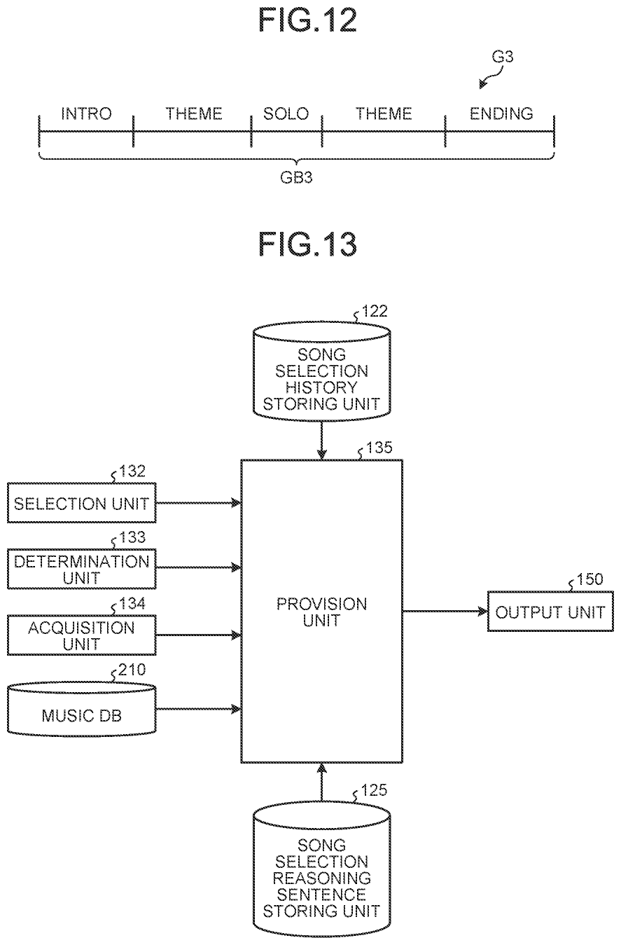

FIGS. 10 to 12 are diagrams illustrating examples of an analysis result of the song content of the present disclosure. By a process of the acquisition unit 134, as illustrated in FIGS. 10 to 12, detailed structure information GB1 to GB3 of the song content such as the intro, a theme part, a chorus part, an interlude part, and the ending is acquired for each piece of song content G1 to G3. On the basis of the structure information GB1 to GB3, the acquisition unit 134 acquires, as the constraint information, the position of the superimposable portion on which the information (voice data) related to the song selection reason can be superimposed and the length of time of the superimposable portion. In other words, the acquisition unit 134 can acquire positions and lengths of time of the intro, the interlude part, the ending, and the like included in the song content as the superimposable portion. Examples of the superimposable portion include the positions and lengths of time of the intro, the interlude part, and the ending, which are components of the song content; however, this example is not particularly limiting.

On the basis of the constraint information indicating the constraint based on the output format of the information acquired by the acquisition unit 134, the provision unit 135 provides information regarding the song selection reason of the song content output in the output format. The provision unit 135 provides information regarding the selection reason together with the song content at the timing of reproducing the song content. The provision unit 135 converts a song selection reasoning sentence, which is the information regarding the song selection reason, into voice. The provision unit 135 provides the user with the song selection reason of the song content by superimposing the song selection reasoning sentence converted into voice over the song content and outputting the song selection reasoning sentence by voice. FIG. 13 is a diagram illustrating an exemplary process by the provision unit 135 of the present disclosure.

As illustrated in FIG. 13, the provision unit 135 selects a song selection reasoning sentence that provides the user with the song selection reason of the song content on the basis of the information acquired from the selection unit 132, the determination unit 133, the acquisition unit 134, the music DB 210, and the like. The provision unit 135 acquires a sensor analysis result that has been used when the selection unit 132 has selected the song content and determines a song selection reason on the basis of the sensor analysis result that has been acquired. Alternatively, the provision unit 135 may adopt, as the song selection reason, a keyword or the like included in a search query for the selection unit 132 to search and to acquire the song content. For example, the provision unit 135 can determine the song selection reason at the timing when the selection of the song content is completed by the selection unit 132. The provision unit 135 can also determine a song selection reason on the basis of information such as the order of new arrival or the order of sales of the song content acquired from the determination unit 133, artist information provided from a servicer of the song content, and the like. On the basis of the analysis result of the song content acquired by the acquisition unit 134, the provision unit 135 specifies the position and the length of time of the superimposable portion of the song content indicated as a constraint when the song selection reason is provided together with the song content. The provision unit 135 selects a song selection reasoning sentence that can be output by voice on the basis of at least one of the position or the length of time of the superimposable portion indicated as a constraint from the plurality of song selection reasoning sentences having different lengths prepared in advance and stored in the song selection reasoning sentence storing unit 125. In a case where there is a plurality of superimposable portions in the song content, the provision unit 135 may select song selection reasoning sentences to be superimposed on respective superimposable portions. Alternatively, the provision unit 135 may determine at least one of the plurality of superimposable portions as the superimposable portion of the song selection reasoning sentence and select a song selection reasoning sentence based on at least one of the position or the length of time of the superimposable portion that has been determined. In a case where at least one of the plurality of superimposable portions is determined as the superimposable portion of a song selection reasoning sentence, the priority order for selection as the superimposable portion is previously set to the components such as the intro or the interlude part that can be included in the song content. Then, the provision unit 135 selects a superimposable portion from among the plurality of superimposable portions on the basis of such a priority order.

Furthermore, in a case where a song selection reasoning sentence including the plurality of song selection reasons does not satisfy the constraint, the provision unit 135 may provide the song selection reason to the user on the basis of the importance of the song selection reason that is set in advance. That is, in a case where the length of time when the song selection reasoning sentence including the plurality of song selection reasons is output by voice exceeds the length of time of the superimposable portion, the provision unit 135 selects a song selection reasoning sentence including a song selection reason selected in accordance with the importance of the song selection reason.

Specifically, the provision unit 135 selects the song selection reasoning sentence on the basis of the song selection reason output rule (FIG. 4) stored in the song selection reason output rule storing unit 124. In other words, the provision unit 135 determines that the importance is higher in the order of the intent included in the user's utterance and the behavior explicitly performed by the user or the situation. In a case where the intent included in the user's utterance is included in the plurality of song selection reasons, the provision unit 135 preferentially selects a song selection reasoning sentence including at least the intent included in the user's utterance as the song selection reason. Furthermore, in a case where the behavior explicitly performed by the user or the situation is included in a plurality of song selection reasons, the provision unit 135 selects a song selection reasoning sentence including the behavior explicitly performed by the user or the situation as the song selection reason on the condition that the intent included in the user's utterance is not included. Note that, even in a case where the intent included in the user's utterance is included in the plurality of song selection reasons, if the length of time of the superimposable portion allows, the provision unit 135 may select a song selection reasoning sentence including the intent included in the user's utterance and the behavior explicitly performed by the user or the situation as the song selection reason.

An example of the song selection reasoning sentence provided to the user by the provision unit 135 will be described. FIGS. 14 to 22 are tables illustrating examples of song selection reasoning sentences provided by the provision unit 135 of the present disclosure. Note that the exemplary sentences illustrated in FIGS. 14 to 22 exemplify a part of a plurality of exemplary sentences created by a system administrator in accordance with various song selection reasons that are assumed in advance. The system administrator can assume the position and the length of time of the superimposable portion of the song content to some extent and create a song selection reasoning sentence on the basis of the position and the length of time that are assumed.

FIG. 14 is a table illustrating examples of the song selection reasoning sentence in which the song selection reason is the user's high stress level. FIG. 14 is a table illustrating a part of a plurality of exemplary sentences prepared in advance depending on the position of the superimposable portion of the song content. As illustrated in FIG. 14, in a case where the position of the superimposable portion is in the intro or before reproduction of the song, the provision unit 135 can provide a sentence with a closing phrase of “We will play a relaxation song recommended to you to relieve your stress”. Moreover, as illustrated in FIG. 14, in a case where the position of the superimposable portion is the interlude part (during the song: during reproduction of the song), the provision unit 135 can provide a sentence with a closing phrase of “Playing a relaxation song recommended to you to relieve your stress”. Furthermore, as illustrated in FIG. 14, in a case where the position of the superimposable portion is in the ending or after reproduction of the song, the provision unit 135 can provide a sentence with a closing phrase of “We played a relaxation song recommended to you to relieve your stress”. As described above, the provision unit 135 can select and provide a sentence having a different closing phrase (wording) depending on the position of the superimposable portion of the song content from among the plurality of song selection reasoning sentences prepared in advance even when the song selection reasoning sentences provide the same song selection reason to the user. Note that the song selection reasoning sentence provided before reproduction of the song may not be the same as the song selection reasoning sentence that matches the length of the intro, and a song selection reasoning sentence to be provided before reproduction of the song may be prepared. Similarly, the song selection reasoning sentence provided after reproduction of the song may not be the same as the song selection reasoning sentence that matches the length of the ending, and a song selection reasoning sentence to be provided after reproduction of the song may be prepared.

In addition, FIG. 15 is a table illustrating examples of the song selection reasoning sentence in which the song selection reasons are the user's high stress level and the user's vocal preference. The stress level is acquired from a recognition result of the biological information of the user by the sensor input analyzing unit 131. The user's vocal preference is acquired, for example, on the basis of the user basic information. FIG. 15 is a table illustrating examples of a plurality of sentences having different lengths prepared in advance as song selection reasoning sentences that provide the same song selection reason to the user.

As in the exemplary sentence illustrated in FIG. 15, the provision unit 135 can provide the user with a song selection reasoning sentence selected depending on the length of the superimposable portion from among the plurality of song selection reasoning sentences in which the song selection reason is the user's high stress level and the user's vocal preferences. For example, in a case where FIG. 15 illustrates exemplary sentences prepared for the intro, the provision unit 135 can select and provide the upper sentence illustrated in FIG. 15 if the intro is short and can select and provide the lower sentence illustrated in FIG. 15 if the intro is long. In this manner, the provision unit 135 can select a song selection reasoning sentence from among the plurality of song selection reasoning sentences having different lengths that are prepared in advance on the basis of the position and the length of time of the superimposable portion.

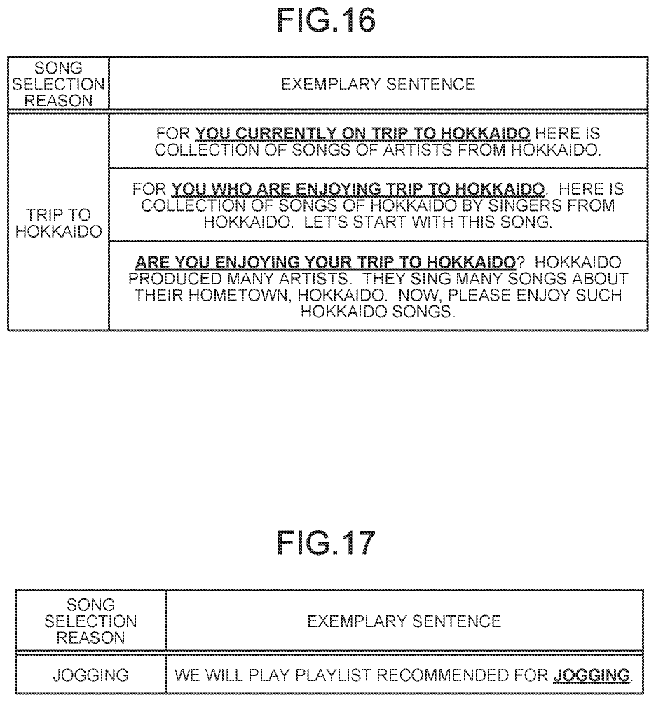

FIG. 16 is a table illustrating examples of the song selection reasoning sentence in which the song selection reason is that the user is traveling in Hokkaido. The situation of the user that the user is traveling in Hokkaido is acquired on the basis of an analysis result such as position information of the user by the sensor input analyzing unit 131. FIG. 16 is a table illustrating examples of a plurality of sentences having different lengths prepared in advance as song selection reasoning sentences that provide the same song selection reason to the user.

As in the exemplary sentence illustrated in FIG. 16, the provision unit 135 can provide the user with a song selection reasoning sentence selected depending on the length of the superimposable portion from among the plurality of song selection reasoning sentences in which the song selection reason is that the user is traveling in Hokkaido. For example, in a case where FIG. 16 illustrates exemplary sentences prepared for the intro, the provision unit 135 can select and provide any one of the upper, the middle, and the lower sentences illustrated in FIG. 16 in accordance with the length of the intro. In this manner, the provision unit 135 can select a song selection reasoning sentence from among the plurality of song selection reasoning sentences having different lengths that are prepared in advance on the basis of the position and the length of time of the superimposable portion.

FIG. 17 is a table illustrating an example of a song selection reasoning sentence in which the song selection reason is that the user is jogging. The fact that the user is jogging is acquired on the basis of a recognition result regarding the user's behavior or the situation, various types of sensor information, position information, and a recognition result of biological information by the sensor input analyzing unit 131. The provision unit 135 can select, for example, the song selection reasoning sentence of the exemplary sentence illustrated in FIG. 17 from among the plurality of song selection reasoning sentences prepared in advance depending on the position and the length of the superimposable portion of the song content and provide the song selection reasoning sentence to the user.

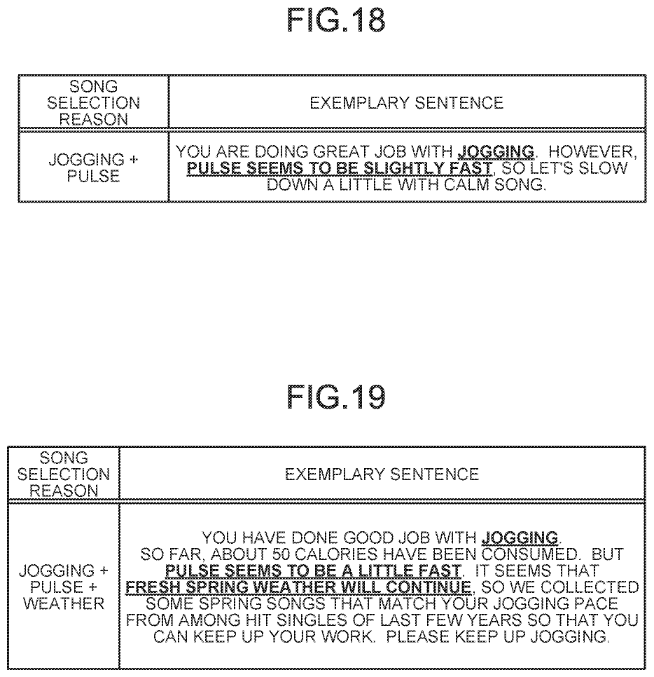

FIG. 18 is a table illustrating an example of a song selection reasoning sentence that provides the user with the fact that the user is jogging and that the pulse is fast as the song selection reason. The fact that the user is jogging and that the pulse is fast is acquired on the basis of a recognition result regarding the user's behavior or the situation, various types of sensor information, position information, and a recognition result of biological information by the sensor input analyzing unit 131. The provision unit 135 can select, for example, the song selection reasoning sentence of the exemplary sentence illustrated in FIG. 18 from among the plurality of song selection reasoning sentences prepared in advance depending on the position and the length of the superimposable portion of the song content and provide the song selection reasoning sentence to the user.

FIG. 19 is a table illustrating an example of a song selection reasoning sentence in which the song selection reason is that the user is jogging, that the pulse is fast, and that the mild weather in spring continues. The fact that the user is jogging and that the pulse is fast is acquired on the basis of a recognition result regarding the user's behavior or the situation, various types of sensor information, position information, and a recognition result of biological information by the sensor input analyzing unit 131. The continuation of the mild weather in spring is obtained based on external information. The provision unit 135 can select, for example, the song selection reasoning sentence of the exemplary sentence illustrated in FIG. 19 from among the plurality of song selection reasoning sentences prepared in advance depending on the position and the length of the superimposable portion of the song content and provide the song selection reasoning sentence to the user.

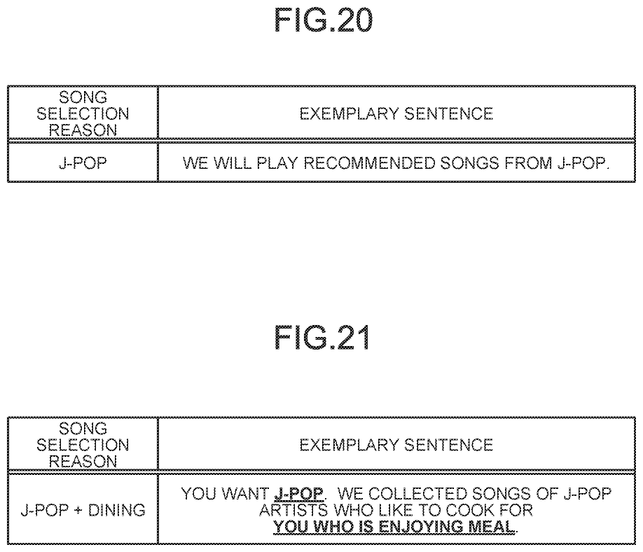

FIG. 20 is a table illustrating an example of a song selection reasoning sentence in which the song selection reason is the intent included in the user's utterance (“Play J-POP”). The intent of the user's utterance is acquired from a recognition result of the intent of the user's utterance by the sensor input analyzing unit 131. The provision unit 135 can select, for example, the song selection reasoning sentence of the exemplary sentence illustrated in FIG. 20 from among the plurality of song selection reasoning sentences prepared in advance depending on the position and the length of the superimposable portion of the song content and provide the song selection reasoning sentence to the user.

FIG. 21 is a table illustrating a song selection reasoning sentence that provides the user with the intent included in the user's utterance (“Play J-POP”) and the user's situation (dining) as the song selection reason. The fact that the user is dining is acquired on the basis of, for example, various types of sensor input, position information, external information, and the like. The provision unit 135 can select, for example, the song selection reasoning sentence of the exemplary sentence illustrated in FIG. 21 from among the plurality of song selection reasoning sentences prepared in advance depending on the position and the length of the superimposable portion of the song content and provide the song selection reasoning sentence to the user.

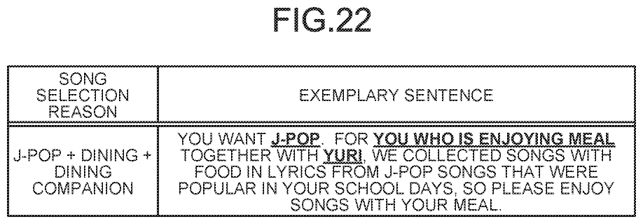

FIG. 22 is a table illustrating a song selection reasoning sentence in which the song selection reason is the intent included in the user's utterance (“Play J-POP”) and the user's situation (dining with a certain person “Yuri san”). Whether or not the user is with a certain person is acquired on the basis of, for example, a recognition result of the user situation by the sensor input analyzing unit 131. The provision unit 135 can select, for example, the song selection reasoning sentence of the exemplary sentence illustrated in FIG. 22 from among the plurality of song selection reasoning sentences prepared in advance depending on the position and the length of the superimposable portion of the song content and provide the song selection reasoning sentence to the user.

As illustrated in FIGS. 17 to 22, the number of characters of the song selection reasoning sentence provided by the provision unit 135 increases as more song selection reasons overlap, and a more detailed song selection reason is provided to the user.

The provision unit 135 superimposes, over the song content, voice data of the song selection reasoning sentence that provides the user with the song selection reason of the song content and outputs the voice data from the output unit 150 together with the song content to provide the voice data to the user. Specifically, the provision unit 135 converts the song selection reasoning sentence into voice data by text to speech (TTS) technology. Subsequently, the provision unit 135 specifies the superimposable portion of the voice data of the song selection reasoning sentence on the basis of an analysis result of the song content acquired by the acquisition unit 134. Then, the provision unit 135 superimposes the song selection reasoning sentence selected from the information of the song selection reasoning sentences stored in the song selection reasoning sentence storing unit 125 over the corresponding superimposable portion in the song content in accordance with the length of time of the superimposable portion and provides the song selection reasoning sentence to the user. For example, the provision unit 135 superimposes the voice data of the song selection reasoning sentence corresponding to the length of time of the intro over the intro, superimposes the voice data of the song selection reasoning sentence corresponding to the length of time of the interlude part over the interlude part, and superimposes the song selection reasoning sentence corresponding to the ending over the ending.

When performing the superimposition, the provision unit 135 may adjust the level of the signal of the song content so that the voice is easily heard.

The input unit 140 is a processing unit for receiving various operations from a user or the like who uses the information processing device 1. The input unit 140 receives input of various types of information via, for example, a keyboard, a touch panel, or the like.

The output unit 150 is a processing unit for outputting various types of information. The output unit 150 is, for example, a display 151, a speaker 152, or the like. The output unit 150 can output the voice data of the song selection reason superimposed on the song content together with the song content to be reproduced via the speaker 152, for example.

[1-3. Procedure of Processes of Information Processing Device According to First Embodiment]

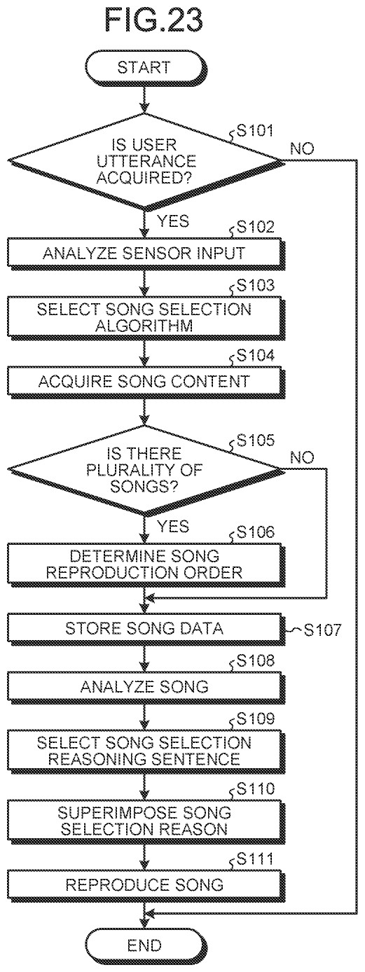

A procedure of the information processing device according to the first embodiment will be described by referring to FIG. 23. FIG. 23 is a flowchart illustrating a procedure of processes of the information processing device 1 according to the first embodiment of the present disclosure. The processes illustrated in FIG. 23 are executed by the control unit 130 and the units included in the control unit 130.

As illustrated in FIG. 23, the sensor input analyzing unit 131 decides whether or not there has been voice input of a user of the information processing device 1 via the microphone (Step S101).

If it is decided that there has been voice input (Step S101; Yes), the sensor input analyzing unit 131 executes a sensor input analysis process on the basis of input from the microphone 11, the camera 12, and various sensors (Step S102).

The selection unit 132 executes a selection process of a song selection algorithm on the basis of the analysis result of the sensor input and the like (Step S103). A search query for searching and acquiring the song content that match the song selection reason from the music DB 210 is generated by the song selection algorithm selected by the selection unit 132.

The selection unit 132 searches and acquires the song content from the music DB 210 on the basis of the search query that has been generated (Step S104).

The determination unit 133 decides whether or not there is a plurality of pieces of song content acquired by the selection unit 132 (Step S105).

If it is decided that there is a plurality of pieces of song content (Step S105; Yes), the determination unit 133 determines the reproduction order of the song content (Step S106) and stores the song content in the reproduction song storing unit 123 (Step S107).

On the other hand, if it is decided that there is no plurality of pieces of song content (Step S105; No), the determination unit 133 proceeds to the process procedure of Step S107 described above.

The acquisition unit 134 analyzes the structure of the song content acquired by the selection unit 132 (Step S108).

The provision unit 135 selects a song selection reasoning sentence for providing the user with the song selection reason of the song content (Step S109). The provision unit 135 selects the song selection reasoning sentence on the basis of information acquired from, for example, the selection unit 132, the determination unit 133, the acquisition unit 134, the music DB 210, and the like. The provision unit 135 selects a song selection reasoning sentence that can be output by voice in accordance with the position and the length of time of the superimposable portion indicated as a constraint from among the plurality of song selection reasoning sentences having different lengths that is prepared in advance. Furthermore, in a case where it is not possible to provide a song selection reasoning sentence including the plurality of song selection reasons in accordance with the length of time of the superimposable portion, the provision unit 135 may select the song selection reasoning sentence on the basis of the importance of the song selection reason set in advance.

The provision unit 135 converts and selects the song selection reasoning sentence into voice data by the text to speech (TTS) technology and superimposes the song selection reason over the song content (Step S110).

Then, the provision unit 135 reproduces the song content over which the voice data of the song selection reasoning sentence is superimposed (Step S111) and ends the processing illustrated in FIG. 23.

In Step S101 described above, if it is decided that there is no voice input (Step S101; No), the sensor input analyzing unit 131 ends the processes illustrated in FIG. 23.

[1-4. Modification of First Embodiment]

In the first embodiment, the example has been described in which the provision unit 135 selects a song selection reasoning sentence that can be output by voice in accordance with the position and the length of time of the superimposable portion indicated as a constraint from among the plurality of song selection reasoning sentences having different lengths that is prepared in advance. However, there is no need to be particularly limited to this example. For example, when providing a song selection reasoning sentence including a plurality of song selection reasons in accordance with the length of time of the superimposable portion, the provision unit 135 may provide the song selection reason by shortening or extending the song selection reasoning sentence in accordance with the length of time of the superimposable portion using a sentence summarizing technology or the like. Furthermore, in a case where there is no constraint on the position of the superimposable portion, the provision unit 135 may select the song selection reasoning sentence depending on only the length of the superimposable portion. For example, the acquisition unit 134 acquires the length of the superimposable portion of the song content. The system administrator prepares in advance a plurality of song selection reasoning sentences that can be selected regardless of whether the position of the superimposable portion is at the intro, the interlude part, or the ending and stores the plurality of song selection reasoning sentences in the song selection reasoning sentence storing unit 125. The provision unit 135 acquires the length of the superimposable portion of the song content from the acquisition unit 134 and selects a song selection reasoning sentence from the plurality of song selection reasoning sentences stored in the song selection reasoning sentence storing unit 125 depending on the length of the superimposable portion. In this manner, the provision unit 135 can provide the user with the song selection reasoning sentence selected in accordance with only the length of the superimposable portion without being affected by the position of the superimposable portion.

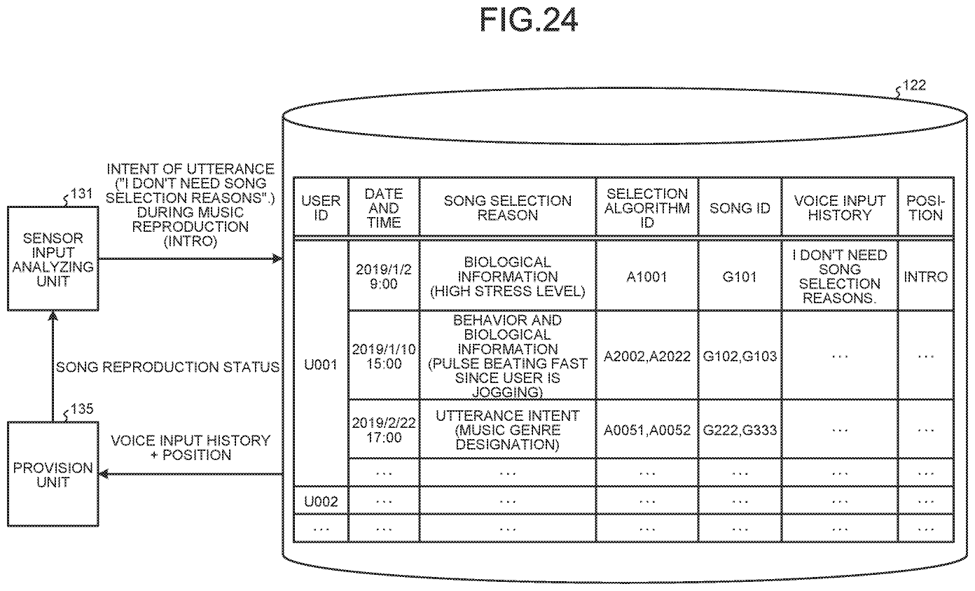

Furthermore, in a case where there is a plurality of superimposable portions in the song content, the provision unit 135 may analyze information of whether or not there has been voice input indicating that superimposition of the song selection reason is not desired from the past history of the user to determine the superimposable portion of the song selection reasoning sentence. FIG. 24 is a diagram illustrating the outline of processes according to the modification of the first embodiment of the present disclosure. As illustrated in FIG. 24, the sensor input analyzing unit 131 analyzes the voice input from the microphone 11 and analyzes the intent of the user's utterance when reproducing the song content. Then, in a case where the intent of the user's utterance that superimposition of the song selection reason is not desired is specified as a result of the analysis, the sensor input analyzing unit 131 associates the user's voice input history and information of the song content and stores them in the song selection history storing unit 122. The sensor input analyzing unit 131 specifies the reproduction position of the song content corresponding to the user's voice input time point on the basis of the reproduction status of the song content acquired from the provision unit 135, for example, and associates the specified reproduction position of the song content with the intent of the user's utterance. The sensor input analyzing unit 131 may acquire, as the reproduction position of the song content, for example, information of components such as the intro, the interlude part, and the ending part of the song content, or in a case of before or after reproduction, information before or after the reproduction may be acquired. Note that, in a case where a portion where superimposition of the song selection reason is not desired has been successfully specified from the intent of the user's utterance on the basis of the analysis result of the user's voice such as “I don't need song selection reasons in the intro”, the sensor input analyzing unit 131 may associate such a portion with the user's voice input history. The provision unit 135 refers to the user's voice input history stored in the song selection history storing unit 122 when selecting the song selection reasoning sentence in Step S109 illustrated in FIG. 23, for example. Then, in a case where there is a voice input history in which the user does not desire to superimpose the song selection reason in the intro of the song content, the provision unit 135 determines a superimposable portion of the song selection reasoning sentence from among superimposable portions other than the intro.

Note that the provision unit 135 may provide the song selection reason to the user without superimposing the song selection reason over the song content in a case where it is difficult to superimpose a song selection reasoning sentence on the superimposable portion even if the song selection reasoning sentence has been selected on the basis of the preset degree of importance of the song selection reason. For example, the provision unit 135 converts the song selection reasoning sentence including all the song selection reasons into voice and outputs the voice before or after reproduction of the song content.

Alternatively, instead of selecting a song selection reasoning sentence, the provision unit 135 can generate a song selection reasoning sentence that can be output by voice on the basis of at least one of the position or the length of time indicated as a constraint in the constraint information and provide the song selection reason on the basis of the song selection reasoning sentence that has been generated. In other words, the provision unit 135 generates a song selection reasoning sentence having a different expression or a different number of characters on the basis of at least one of the position and the length of time of the superimposable portion acquired by the acquisition unit 134. Furthermore, in a case where there is a plurality of superimposable portions in the song content acquired by the acquisition unit 134, the provision unit 135 generates each song selection reasoning sentence having a different expression or a different number of characters on the basis of at least one of the position or the length of time of each superimposable portion.

Furthermore, in a case where there is a plurality of superimposable portions in the song content acquired by the acquisition unit 134, the provision unit 135 may generate each song selection reasoning sentence having different content by changing the expression or the number of characters of the song selection reasoning sentence depending on the type of such a superimposable portion. For example, an exemplar case is described in which the song content includes a relatively long intro and a short ending as superimposable portions. In this case, the provision unit 135 can generate a song selection reasoning sentence having the number of characters matching the length of the intro by using an expression considered more suitable for the intro and can generate a song selection reasoning sentence having the number of characters matching the length of the ending by using an expression suitable for the ending.

Note that generation of a song selection reasoning sentence by the provision unit 135 can be implemented by automatic sentence generation technology using the song selection reason (stress, healing sound, relaxation, etc.) used at the time of selecting the song content as a keyword from the song selection algorithm selected by the selection unit 132. At this time, keywords acquired from the selection unit 132 or the like can be used as a material for generating the song selection reasoning sentence.

Note that the provision unit 135 may specify a superimposable portion that does not hinder the flow when the song content is reproduced from a plurality of superimposable portions included in the song content on the basis of an analysis result of each piece of the song content by the acquisition unit 134. Alternatively, the provision unit 135 may receive designation of a superimposable portion in advance from the artist side. Designation of a superimposable portion from the artist side may be stored in, for example, the music DB 210 or the like.

### 2. SECOND EMBODIMENT

[2-1. Exemplary Processes of Information Processing Device According to Second Embodiment]

Hereinafter, an example of processes of the information processing device 1 according to a second embodiment will be described by referring to the drawings. The processes of the information processing device 1 according to the second embodiment is different from those of the first embodiment in the process of the provision unit 135 described below.

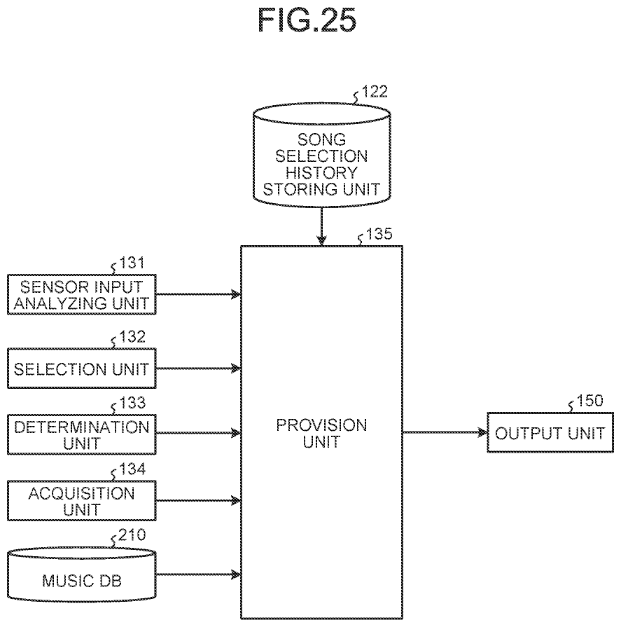

FIG. 25 is a diagram illustrating an exemplary process of the provision unit 135 according to the second embodiment of the present disclosure. The provision unit 135 may acquire an analysis result of sensor input from the sensor input analyzing unit 131 and change the content of the song selection reasoning sentence that has been selected in accordance with the current situation of the user on the basis of the analysis result of the sensor input that has been acquired.

Specifically, the provision unit 135 acquires an analysis result of sensor input from the sensor input analyzing unit 131, for example, in a case where a certain period of time has elapsed from the time when the song selection reasoning sentence has been selected at timing when the song selection reason is provided to the user. Subsequently, the provision unit 135 decides whether or not there has been a change in the analysis result of sensor input that is the basis of the song selection reason at the timing when the song selection reason has been determined and the timing when the song selection reason is provided. Then, the provision unit 135 determines to change the content of the song selection reasoning sentence so that the song selection reason is consistent with the user's current situation (current state) if there is a change in the analysis result of sensor input that is the basis of the song selection reason. The change in the content of the song selection reasoning sentence includes a change of expression and a change in the content. Hereinafter, processes by the provision unit 135 according to the second embodiment will be described by referring to the drawings.

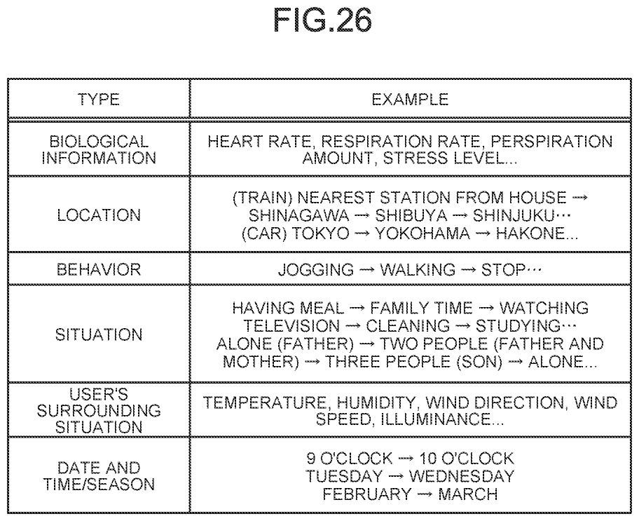

FIG. 26 is a table illustrating exemplary changes in an analysis result of sensor input according to the second embodiment of the present disclosure. As illustrated in FIG. 26, some of analysis results of sensor input analyzed by the sensor input analyzing unit 131 vary from moment to moment. For this reason, there are cases where the situation of the user at the timing when the song selection reason has been determined and the situation of the user at the timing when the song selection reason is provided do not match.

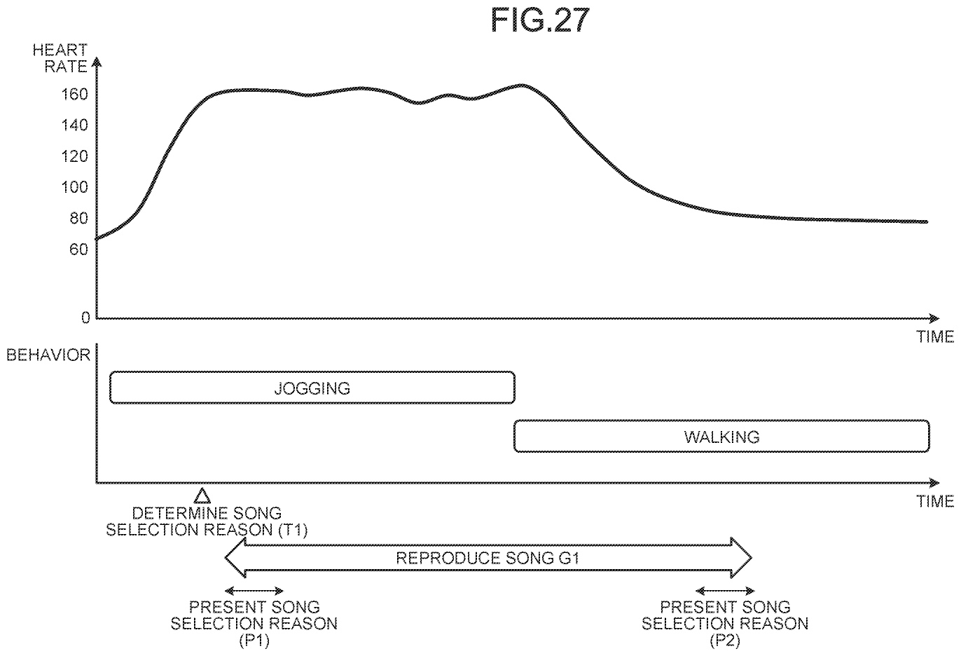

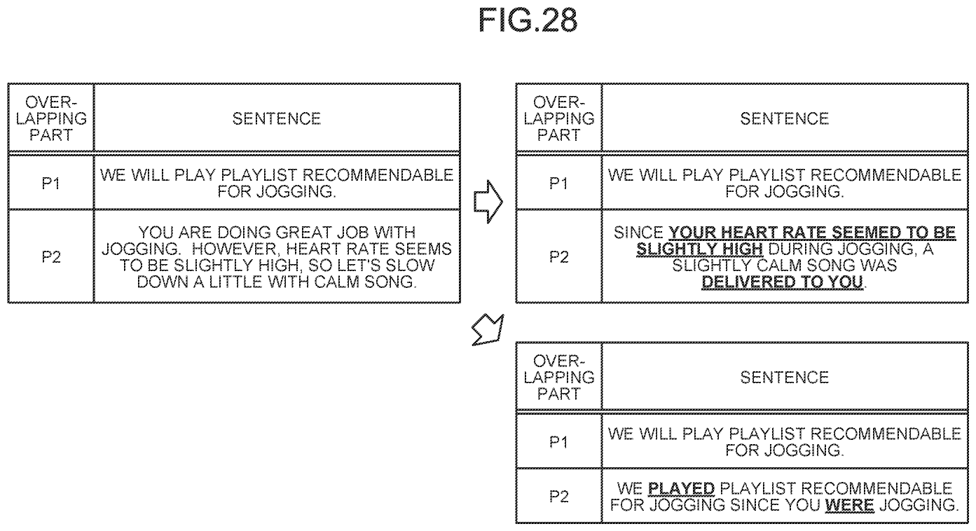

FIG. 27 is a diagram illustrating exemplary changes in the behavior and the situation of a user according to the second embodiment of the present disclosure. FIG. 28 is a diagram illustrating an example of a song selection reasoning sentence corresponding to FIG. 27 of the present disclosure. FIG. 27 is a diagram illustrating the relationship between the temporal change of the user's behavior and the situation and the provision timing of the song selection reason. FIG. 28 is a diagram illustrating exemplary changes in song selection reasoning sentences in accordance with changes in the user's behavior and the situation. FIG. 28 is a diagram illustrating exemplary changes in a selected song selection reasoning sentence that has been selected by the provision unit 135 or a song selection reasoning sentence that has been the generated by the provision unit 135.

In the example illustrated in FIG. 27, for example, at timing of time T1, the user's behavior and the situation such as “jogging” or “high heart rate” are determined as the song selection reason to be provided to the user. In addition, in the example illustrated in FIG. 26, it is indicated that the song selection reason determined at the timing of time T1 is provided to the user in a first half (P1) and a second half (P2) of song content G1. Furthermore, the example illustrated in FIG. 27 indicates that the behavior of the user has changed from jogging to walking in the middle of reproduction of the song content G1 and that the heart rate of the user is also substantially flat from the middle of walking.

In the situation illustrated in FIG. 27, as illustrated in FIG. 28, the song selection reason “We will play a playlist recommendable for jogging” provided to the user in the first half (P1) of the song content G1 is consistent with the current state of the user. On the other hand, the song selection reason “You are doing a great job with jogging. However, the heart rate seems to be slightly high, so let's slow down a little with a calm song.” that is provided to the user in the second half (P2) of the song content G1 is not consistent with the current state of the user. For this reason, there is a possibility that the user feels uncomfortable.

Therefore, the provision unit 135 determines to change and to thereby provide the content of the song selection reasoning sentence in the second half (P2) of the song content in accordance with the current situation of the user. For example, as illustrated in FIG. 28, the provision unit 135 changes the content of the song selection reasoning sentence to an expression including the past tense such as “Since your heart rate seemed to be slightly high during jogging, a slightly calm song was delivered to you”. Alternatively, as illustrated in FIG. 28, the provision unit 135 changes the content of the song selection reasoning sentence to an expression including the past tense such as “We played a playlist recommendable for jogging since you were jogging”. As a result, it is possible to avoid providing the user with a song selection reason that is not consistent with the current state of the user, and it is possible to provide a song selection reason that does not give the user a sense of discomfort.

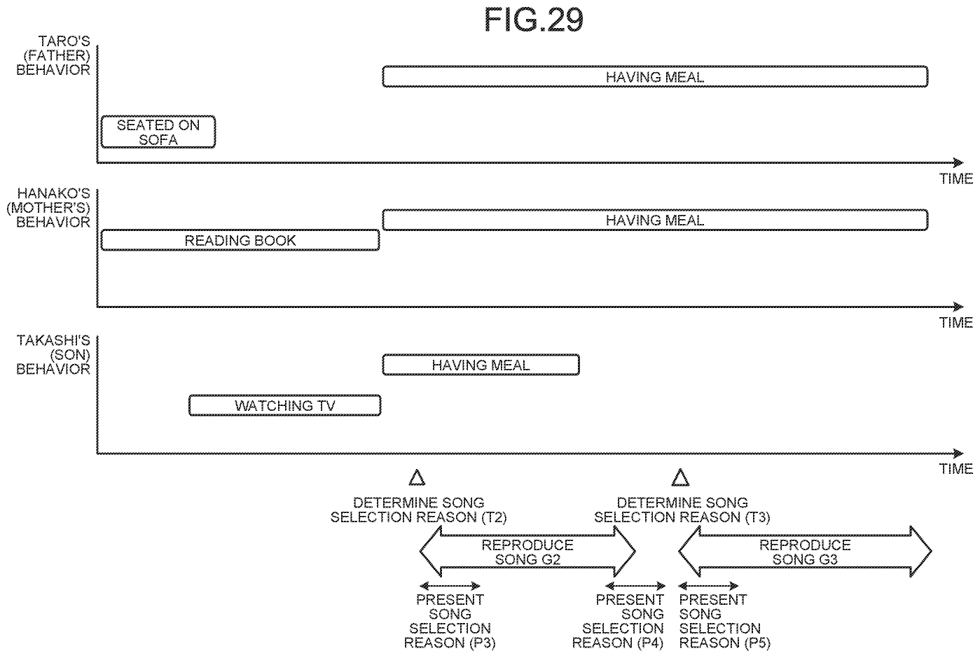

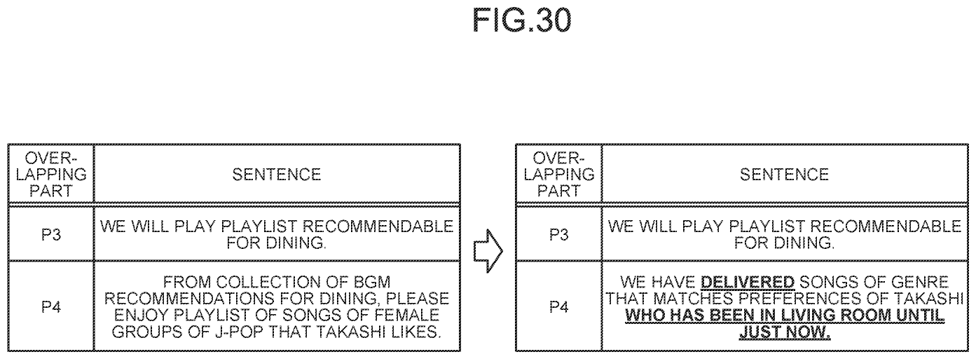

FIG. 29 is a diagram illustrating other exemplary changes in the behavior and the situation of a user according to the second embodiment of the present disclosure. FIG. 30 is a diagram illustrating an example of a song selection reasoning sentence corresponding to FIG. 29 of the present disclosure. FIG. 29 is a diagram illustrating the relationship between the temporal change in the user's behavior and the situation and timing at which the song selection reason is provided. FIG. 30 is a diagram illustrating exemplary changes in song selection reasoning sentences in accordance with changes in the user's behavior and the situation.

In the example illustrated in FIG. 29, for example, at timing of time T2, the behavior and the situation (for example, dining) of Taro (father), Hanako (mother), and Takashi (son) are determined as the song selection reasons. Then, in the example illustrated in FIG. 29, it is indicated that the song selection reason determined at the timing of time T2 is provided to the user in a first half (P3) and a second half (P4) of song content G2. In addition, in the example illustrated in FIG. 29, it is indicated that the behavior and the situation of Takashi (son) has changed (finished dining) in the middle of reproduction of the song content G2.

In the situation illustrated in FIG. 29, as illustrated in FIG. 30, the song selection reason “We will play a playlist recommendable for dining.” provided in the song content G2 and the first half (P3) of G3 is consistent with the current state of the user. On the other hand, the song selection reason “From a collection of BGM recommendations for dining, please enjoy a playlist of songs of female groups of J-POP that Takashi may like.” provided in the second half (P4) of the song content G2 is not consistent with the current state of the user. Therefore, there is a possibility that users, Taro (father) and Hanako (mother), feel uncomfortable.

Therefore, the provision unit 135 determines to change and to thereby provide the content of the song selection reasoning sentence in the second half (P4) of the song content G2 in accordance with the current situation of the user. For example, as illustrated in FIG. 30, the provision unit 135 changes the content of the song selection reasoning sentence to an expression including a past tense such as “We delivered songs of a genre that suits the preference of Takashi who was in the living room until just now”. As a result, it is possible to avoid providing the user with a song selection reason that is not consistent with the current state of the user, and it is possible to provide a song selection reason that does not give the user a sense of discomfort.

In addition, in a case where the provision unit 135 decides that there is a change in the analysis result of sensor input that is the basis of the song selection reason, the content of the song selection reasoning sentence may be changed and thereby provided on the condition that the importance of such a song selection reason is high. Specifically, the provision unit 135 decides whether or not there has been a change in the analysis result of sensor input that is the basis of the song selection reason at the timing when the song selection reason has been determined and the timing when the song selection reason is provided. In a case where it is decided that there is a change in the analysis result, the provision unit 135 determines to change the sentence expression of the song selection reasoning sentence on the condition that the importance of the song selection reason is high. Furthermore, in a case where it is decided that there has been a change in the analysis result, the provision unit 135 determines not to provide the song selection reason on the condition that the importance of the song selection reason is not high.

In other words, the provision unit 135 determines to change and to thereby provide the content of the song selection reasoning sentence so that the song selection reason is consistent with the user's current situation (current state) if there is a change in the analysis result of sensor input that is the basis of the song selection reason and the importance of the song selection reason is high. On the other hand, even in a case where there is a change in the analysis result of sensor input that is the basis of the song selection reason, if the importance of the song selection reason is not high, the provision unit 135 determines not to provide the song selection reason.

For example, the provision unit 135 can set “the intent included in the user's utterance” to which “necessary” is defined as the necessity of output in the song selection reason output rules (FIG. 4) and “the behavior explicitly performed by the user or the situation” to which “output unless it is impossible” is defined as song selection reasons of high importance. On the other hand, “the behavior or the situation that the user is less likely to notice” or the like to which “output if possible” is defined can be set as a song selection reason of less importance.

For example, in a case where “jogging” and “high heart rate” are included as the song selection reason, the provision unit 135 can set that “jogging” which corresponds to “the behavior explicitly performed by the user or the situation” can be a song selection reason of high importance. On the other hand, the provision unit 135 can set “high heart rate” which corresponds to “the behavior or the situation that the user is less likely to notice” as a song selection reason of less importance. When there is a change in the analysis result of sensor input that is the basis of these song selection reasons at the timing of providing the song selection reasons, the provision unit 135 determines not to provide, to the user, “high heart rate” which is of less importance. At this time, the provision unit 135 can exclude a song selection reason of low importance and change the content of the song selection reasoning sentence that has been selected to a content including only song selection reasons of high importance. For example, the provision unit 135 provides the user with the song selection reasoning sentence in which the expression is changed to the past tense and “fast heart rate” is excluded, such as “We played a playlist recommendable for jogging since you were jogging.” which is the example illustrated in FIG. 28. In this manner, it is possible to select as finely as possible and to provide the user with a song selection reason that does not make the user feel uncomfortable. Note that, in a case where only song selection reasons having a low importance is included, the provision unit 135 ends the process without changing the content of the song selection reasoning sentence that has been selected and without providing the song selection reason.

[2-2. Procedure of Processes of Information Processing Device According to Second Embodiment]

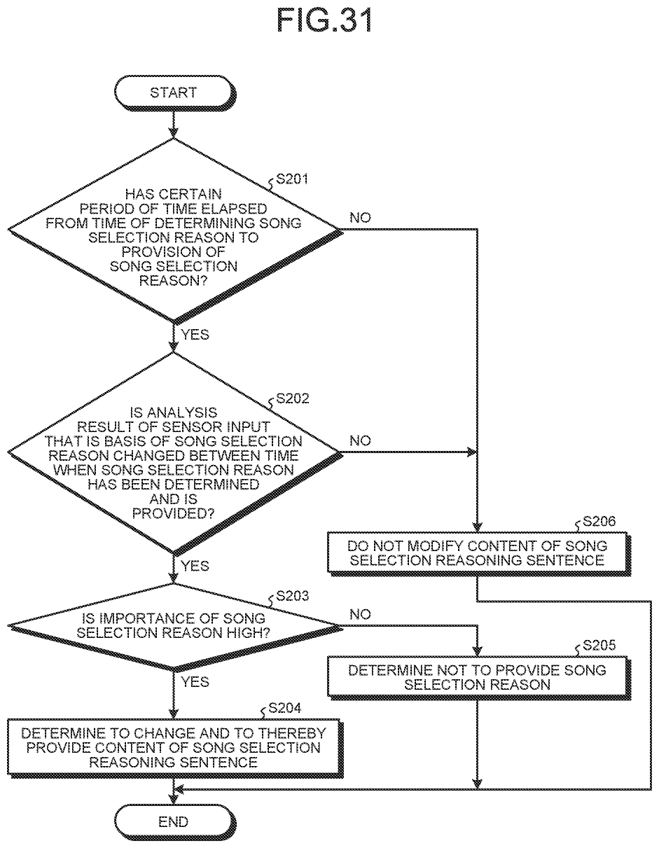

FIG. 31 is a flowchart illustrating a procedure of processes of the information processing device according to the second embodiment of the present disclosure. The processes illustrated in FIG. 31 are mainly executed by the provision unit 135 included in the control unit 130.

As illustrated in FIG. 31, the provision unit 135 decides whether or not a certain period of time has elapsed from the time of determining the song selection reason to provision of the song selection reason (from the timing when the song selection reason has been determined to the timing when the song selection reason is provided) (Step S201). The provision unit 135 can execute the decision of Step S201, for example, by calculating the elapsed time from the determination of the song selection reason at the timing when the song selection reason is provided to the user.

In a case where it is decided that a certain period of time has elapsed by provision of the song selection reason (Step S201; Yes), the provision unit 135 decides whether or not the analysis result of the sensor input that is the basis of the song selection reason has changed between the time when the song selection reason has been determined and is provided (Step S202).

If the provision unit 135 decides that the analysis result of the sensor input that is the basis of the song selection reason has changed between the time when the song selection reason has been determined and is provided (Step S202; Yes), the provision unit 135 decides whether or not the importance of the song selection reason is high (Step S203). For example, in a case where the song selection reason is the intent included in the user's utterance or the behavior explicitly performed by the user, the provision unit 135 can decide that the importance is high.

If the provision unit 135 decides that the importance of the song selection reason is high (Step S203; Yes), the provision unit 135 determines to change and to thereby provide the content of the song selection reasoning sentence that has been selected (Step S204) and ends the processes illustrated in FIG. 31.

On the other hand, if the provision unit 135 decides that the importance of the song selection reason is not high (Step S203; No), the provision unit 135 determines not to provide the song selection reason (Step S205) and ends the processes illustrated in FIG. 31.

In Step S202, if the provision unit 135 decides that the analysis result of the sensor input has not changed between the time when the song selection reason has been determined and is provided (Step S202; No), the provision unit 135 determines not to change the content of the song selection reasoning sentence (Step S206). Then, the provision unit 135 ends the processes illustrated in FIG. 31.

In Step S201 described above, if the provision unit 135 decides that a certain period of time has not elapsed by the time when the song selection reason is provided (Step S201; No), the provision unit 135 proceeds to the process procedure of Step S206 described above.

[2-3. Modification of Second Embodiment]

The provision unit 135 according to the second embodiment constantly monitors the analysis result of sensor input, and when there is a change in the analysis result of the sensor input that is the basis of the song selection at the time of song selection reason, the song content that has been selected may not be reproduced to the end. Moreover, it is preferable that the provision unit 135 newly selects the song content based on the song selection reason corresponding to the analysis result of the sensor input, analyzes the song content of the song that has been selected, and newly reproduces the song content together with the song selection reason. For example, in a case where the favorite music genre of Takashi is quite different from that of Taro and Hanako, song selection is newly performed at timing when Takashi finishes dining and leaves the dining table, for example, at timing T3 illustrated in FIG. 29. As a result, song content that matches the preference of Taro and Hanako is reproduced, and a new song selection reason is presented in a first half (P5) of the song content illustrated in FIG. 29. Therefore, it is possible to provide a music reproduction environment that is more desirable for Taro and Hanako than continuously reproducing the song content of the music genre selected in accordance with the preference of Takashi.

### 3. OTHER EMBODIMENTS

In the embodiments described above, an example has been described in which the information processing device 1 superimposes voice data of a song selection reasoning sentence indicating the song selection reason of the song content over the song content and thereby outputs and provides the voice data to the user, but the present invention does not need to be particularly limited to this example. For example, an information processing device 1 may provide a song selection reasoning sentence to a user by displaying and outputting the song selection reasoning sentence.

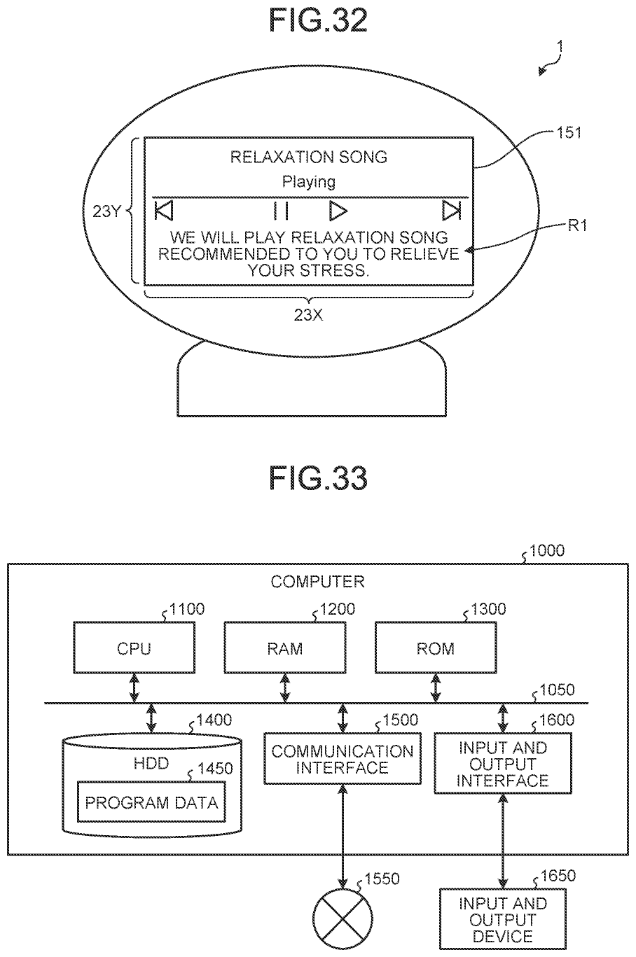

That is, a provision unit 135 of the information processing device 1 provides the song selection reasoning sentence that can be displayed and output in accordance with the display size indicated as a constraint in constraint information. The provision unit 135 selects information regarding the song selection reason that can be displayed and output in accordance with the display size indicated as a constraint from among a plurality of song selection reasoning sentences having different display sizes that is prepared in advance. Alternatively, the provision unit 135 generates a song selection reasoning sentence that can be displayed and output in accordance with the display size indicated as the constraint. Examples of the display size include the length of the width of a display 151 of an output unit 150. FIG. 32 is a diagram illustrating a display example of a song selection reason according to another embodiment of the present disclosure.

As illustrated in FIG. 32, the provision unit 135 of the information processing device 1 converts the song selection reasoning sentence into image data and displays and outputs the converted image data on the display 151 (an example of a display unit) included in the output unit 150 together with the reproduction of the song content. At this time, the provision unit 135 selects the song selection reasoning sentence from a plurality of song selection reasoning sentences having different display sizes that is prepared in advance in accordance with the size of the display area of the display 151. Alternatively, the provision unit 135 generates the song selection reasoning sentence in accordance with the size of the display area of the display 151. For example, as illustrated in FIG. 32, the provision unit 135 can change the content of the song selection reasoning sentence by changing the number of characters of the song selection reasoning sentence or sorting out the song selection reasoning sentences depending on the length of the width 150X of the display area of the display 151.

Among the processes described in the above embodiments, all or a part of the processes described as those performed automatically can be performed manually, or all or a part of the processes described as those performed manually can be performed automatically by a known method. In addition, a process procedure, a specific name, and information including various types of data or parameters illustrated in herein or in the drawings can be modified as appropriate unless otherwise specified. For example, various types of information illustrated in the figures are not limited to information that has been illustrated.

In addition, each component of each device illustrated in the drawings is functionally conceptual and does not need to be necessarily physically configured as illustrated in the drawings. That is, a specific form of distribution and integration of each device is not limited to those illustrated in the figures, and all or a part thereof can be functionally or physically distributed or integrated in any unit depending on various loads, usage status, and the like. For example, the acquisition unit 134 and the provision unit 135 illustrated in FIG. 1 may be functionally or physically integrated.

In addition, the above-described embodiments and modifications can be combined as appropriate within a range where there is no conflict in the process content.

Furthermore, the effects described herein are merely examples and are not limiting, and other effects may be achieved.

### 4. EFFECTS OF INFORMATION PROCESSING DEVICE ACCORDING TO PRESENT DISCLOSURE

As described above, an information processing device (such as an information processing device 1 of an embodiment) according to the present disclosure includes an acquisition unit (acquisition unit 134 of an embodiment) and a provision unit (provision unit 135 of an embodiment). The acquisition unit acquires constraint information indicating a constraint based on an output format of information. On the basis of the constraint information acquired by the acquisition unit, the provision unit provides information regarding the song selection reason to be output in the above-described output format. As a result, the information processing device according to the present disclosure can convey, to the user, the information regarding the song selection reason of the song content without hindering the flow in which the user enjoys the music under the constraint based on the output format.

Moreover, the provision unit outputs the information regarding the song selection reason by voice. As a result, the information processing device according to the present disclosure can convey, to the user, the information regarding the song selection reason by superimposing the information over the song content in an output format by voice.

Furthermore, the above-described constraint information defines at least one of a position or a length of time as a constraint. The provision unit provides the information regarding the song selection reason that can be output by voice in accordance with at least one of a position or a length of time indicated as a constraint in constraint information. As a result, the information processing device according to the present disclosure can convey, to the user, the information regarding the song selection reason of the song content within the constraint of at least one of the position or the length of time defined as a constraint.

Furthermore, the provision unit selects the information regarding the song selection reason that can be output by voice on the basis of at least one of the position or the length of time indicated as the constraint from a plurality of pieces of information regarding the song selection reason which has different lengths and is prepared in advance. As a result, an information processing device according to the present disclosure can select and notify a user of information regarding the song selection reason of the appropriate content of a song by simple processes.

Alternatively, the provision unit generates the information regarding the song selection reason that can be output by voice on the basis of at least one of the position or the length of time indicated as a constraint in the constraint information. As a result, an information processing device according to the present disclosure can generate and notify the user of the information regarding the song selection reason of the appropriate the song content without preparing a plurality of pieces of information regarding the song selection reason in advance.

Furthermore, the acquisition unit analyzes the structure of the song and thereby acquires, as the constraint information, at least one of the position and the length of time of a superimposable portion over which the information regarding the song selection reason subjected to the voice conversion can be superimposed when the music is reproduced. Then, the provision unit provides the information regarding the song selection reason that can be output by voice on the basis of at least one of the position or the length of time of the superimposable portion. As a result, it is possible to select appropriate information regarding the song selection reason of the song content in accordance with the structure of the song and to convey the information to the user.

Alternatively, the provision unit displays and outputs the information regarding the song selection reason on a display unit (the display 151 in the embodiment). As a result, the information processing device according to the present disclosure can convey, to the user, the information regarding the song selection reason of the song content by an output format by display other than voice.

Moreover, the constraint information defines a display size of the display unit as the constraint, and the provision unit provides information regarding the song selection reason that can be output by display in accordance with the display size indicated as the constraint in the constraint information. As a result, the information processing device according to the present disclosure can convey, to the user, the information regarding the song selection reason of the song content within the constraint of display size defined as a constraint.

The provision unit also selects information regarding the song selection reason that can be displayed and output in accordance with the display size indicated as the constraint from among a plurality of pieces of information regarding the song selection reason which has different display sizes and is prepared in advance. As a result, an information processing device according to the present disclosure can select and notify a user of information regarding the song selection reason of the appropriate content of a song by simple processes.

Moreover, the provision unit generates information regarding the song selection reason that can be displayed and output in accordance with the display size indicated as the constraint. As a result, an information processing device according to the present disclosure can generate and notify the user of the information regarding the song selection reason of the appropriate the song content without preparing a plurality of pieces of information regarding the song selection reason in advance.

Furthermore, in a case where it is not possible to provide information regarding the song selection reason including a plurality of song selection reasons in accordance with the length of time of a superimposable portion, the provision unit selects information regarding the song selection reason on the basis of the importance of the song selection reasons set in advance. As a result, the information processing device according to the present disclosure can provide the user with the information regarding the song selection reason of the song content while considering the importance within the constraint of the length of time of the superimposable portion.

Furthermore, the provision unit preferentially selects information regarding the song selection reason including a song selection reason of the highest importance among a plurality of song selection reasons. As a result, the information processing device according to the present disclosure can provide the user with the information regarding the song selection reason of the highest importance within the constraint of the length of time of the superimposable portion.

Meanwhile, in a case where the plurality of song selection reasons does not include a song selection reason of the highest importance, the provision unit preferentially selects information regarding the song selection reason including a song selection reason having a second highest importance following the song selection reason of the highest importance. As a result, the information processing device according to the present disclosure can provide the user with the information regarding the song selection reason having the as high importance as possible within the constraint of the length of time of the superimposable portion.

Furthermore, the information processing device according to the present disclosure further includes a detection unit, a detection result analyzing unit, and a selection unit. The detection unit (the microphone 11, the camera 12, the GPS receiver 13, and the sensors 14 to 21 in the embodiments) detects information regarding a user. The detection result analyzing unit (the sensor input analyzing unit 131 in the embodiments) analyzes a detection result by the detection unit. The selection unit (the selection unit 132 in the embodiments) selects a song selection algorithm for searching and acquiring a song depending on the analysis result by the detection result analyzing unit. As a result, the information processing device according to the present disclosure can provide the user with the song content in accordance with the analysis result of the information regarding the user.

In addition, the provision unit acquires the analysis result of the detection result analyzing unit and decides whether or not there has been a change in the analysis result that is the basis of the song selection reason between the timing when the song selection reason has been determined and the timing when the information regarding the song selection reason is provided. In a case where the provision unit decides that there has been a change in the analysis result, the provision unit changes the content of the information regarding the song selection reason in accordance with the analysis result. As a result, the information processing device according to the present disclosure can avoid providing the user with a song selection reason that is not consistent with the current state of the user and achieve provision of a song selection reason that does not give the user a sense of discomfort.

In addition, in a case where the provision unit decides that there has been a change in the analysis result that is the basis of the song selection reason, it is determined to change and to thereby provide the expression of the information regarding the song selection reason on the condition that the importance of the song selection reason is high. As a result, the information processing device according to the present disclosure can select and provide the user with the information regarding the song selection reason that is consistent with the current state of the user and has high importance.

Furthermore, in a case where it is decided that there has been a change in the analysis result that is the basis of the song selection reason, the provision unit determines not to provide the song selection reason on the condition that the importance of the song selection reason is not high. The information processing device according to the present disclosure can select and provide only information having as high importance as possible with respect to the information regarding the song selection reason that is not consistent with the current state of the user.

### 5. HARDWARE CONFIGURATION

A reception device 10 according to the above-described embodiments is implemented by, for example, a computer 1000 having a configuration as illustrated in FIG. 33. Hereinafter, the information processing devices 1 according to the above-described embodiments will be described as an example. FIG. 33 is a hardware configuration diagram illustrating an example of the computer 1000 that implements the functions of the information processing devices 1 of the present disclosure. The computer 1000 includes a CPU 1100, a RAM 1200, a read only memory (ROM) 1300, a hard disk drive (HDD) 1400, a communication interface 1500, and an input and output interface 1600. Each unit of the computer 1000 is connected by a bus 1050.

The CPU 1100 operates on the basis of a program stored in the ROM 1300 or the HDD 1400 and controls each unit. For example, the CPU 1100 develops a program stored in the ROM 1300 or the HDD 1400 in the RAM 1200 and executes processes corresponding to various programs.

The ROM 1300 stores a boot program such as a basic input output system (BIOS) executed by the CPU 1100 when the computer 1000 is activated, a program dependent on hardware of the computer 1000, and the like.

The HDD 1400 is a recording medium that the computer 1000 can read and non-transiently records programs executed by the CPU 1100, data used by such programs, and the like. Specifically, the HDD 1400 is a recording medium that records a program for implementing the antenna switching process illustrated in FIG. 3, for example.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting the computer 1000 with an input and output device 1650. For example, the CPU 1100 receives data from an input device such as a keyboard and a mouse via the input and output interface 1600. In addition, the CPU 1100 transmits data to an output device such as a display, a speaker, or a printer via the input and output interface 1600. Furthermore, the input and output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as an information processing device 1 according to one of the above-described embodiments, the CPU 1100 of the computer 1000 executes a program (such as a program for implementing the information processing of the present disclosure) loaded on the RAM 1200. As a result, functions such as various processes executed by the control unit 130 of the information processing device 1 are implemented. In addition, the HDD 1400 stores a program for implementing information processing according to the present disclosure, data stored in the storage unit 111, and the like. Note that the CPU 1100 reads program data 1450 from the HDD 1400 and executes the program data, but as another example, these programs may be acquired from another device via the external network 1550.

Note that the present technology can also have the following configurations.

(1)

An information processing device comprising:

an acquisition unit that acquires constraint information indicating a constraint based on an output format of information; and

a provision unit that provides information regarding a song selection reason of a song output in the output format on a basis of the constraint information acquired by the acquisition unit.

(2)

The information processing device according to (1),

wherein the provision unit

outputs the information regarding the song selection reason by voice.

(3)

The information processing device according to (1) or (2),

wherein the constraint information defines at least one of a position or a length of time as the constraint, and

the provision unit

provides information regarding the song selection reason that can be output by voice on a basis of at least one of a position or a length of time indicated as a constraint in the constraint information.

(4)

The information processing device according to any one of (1) to (3),

wherein the provision unit

selects the information regarding the song selection reason that can be output by voice on a basis of at least one of the position or the length of time indicated as the constraint from a plurality of pieces of information regarding the song selection reason which has different lengths and is prepared in advance.

(5)

The information processing device according to any one of (1) to (3),

wherein the provision unit

generates the information regarding the song selection reason that can be output by voice on a basis of at least one of the position or the length of time indicated as the constraint in the constraint information.

(6)

The information processing device according to (3),

wherein the acquisition unit

acquires, as the constraint information for the song, at least one of a position or a length of time of a superimposable portion over which the information regarding the song selection reason that has been converted into voice can be superimposed when the song is reproduced by analyzing a structure of the song, and

the provision unit

provides the information regarding the song selection reason that can be output by voice on a basis of at least one of the position or the length of time of the superimposable portion.

(7)

The information processing device according to (1),

wherein the provision unit

displays and outputs the information regarding the song selection reason on a display unit.

(8)

The information processing device according to (7),

wherein the constraint information defines a display size of the display unit as the constraint, and

the provision unit

provides information regarding the song selection reason that can be output by display in accordance with the display size indicated as the constraint in the constraint information.

(9)

The information processing device according to (8),

wherein the provision unit

selects the information regarding the song selection reason that can be output by display in accordance with the display size indicated as the constraint from a plurality of pieces of information regarding the song selection reason which has different display sizes and is prepared in advance.

(10)

The information processing device according to (9),

wherein the provision unit

generates the information regarding the song selection reason that can be output by display in accordance with the display size indicated as the constraint.

(11)

The information processing device according to any one of (1) to (10),

wherein, in a case where the information regarding the song selection reason including a plurality of song selection reasons does not satisfy the constraint, the provision unit

selects the information regarding the song selection reason on a basis of an importance of the song selection reason that has been set in advance.

(12)

The information processing device according to (11),

wherein the provision unit

preferentially selects information regarding the song selection reason including a song selection reason of a highest importance among the plurality of song selection reasons.

(13)

The information processing device according to (12),

wherein, in a case where the plurality of song selection reasons does not include a song selection reason of the highest importance, the provision unit

preferentially selects information regarding the song selection reason including a song selection reason having a second highest importance following the song selection reason of the highest importance.

(14)

The information processing device according to any one of (1) to (13), further comprising:

a detection unit that detects information regarding a user;

a detection result analyzing unit that analyzes a detection result by the detection unit; and

a selection unit that selects a song selection algorithm for searching and acquiring a song depending on an analysis result by the detection result analyzing unit.

(15)

The information processing device according to (14),

wherein the provision unit

acquires the analysis result of the detection result analyzing unit,

decides whether or not there has been a change in the analysis result that is a basis of the song selection reason between timing when the song selection reason has been determined and timing when the information regarding the song selection reason is provided, and,

in a case where it is decided that there has been a change in the analysis result, changes a content of the information regarding the song selection reason depending on the analysis result.

(16)

The information processing device according to (15),

wherein, in a case where the provision unit decides that there has been a change in the analysis result that is a basis of the song selection reason, the provision unit

determines to change and to thereby provide an expression of the information regarding the song selection reason on a condition that the importance of the song selection reason is high.

(17)

The information processing device according to (15),

wherein, in a case where it is decided that there has been a change in the analysis result that is a basis of the song selection reason, the provision unit

determines not to provide the song selection reason on a condition that the importance of the song selection reason is not high.

(18)

An information processing method, by a computer, comprising:

acquiring constraint information indicating a constraint based on an output format of information; and

providing information regarding a song selection reason of a song output in the output format on a basis of the constraint information that has been acquired.

### REFERENCE SIGNS LIST

1 INFORMATION PROCESSING DEVICE
110 COMMUNICATION UNIT
120 STORAGE UNIT
130 CONTROL UNIT
131 SENSOR INPUT ANALYZING UNIT
132 SELECTION UNIT
133 DETERMINATION UNIT
134 ACQUISITION UNIT
135 PROVISION UNIT
140 INPUT UNIT
150 OUTPUT UNIT

1. An information processing device comprising:
an acquisition unit that acquires constraint information indicating a constraint based on an output format of information; and
a provision unit that provides information regarding a song selection reason of a song output in the output format on a basis of the constraint information acquired by the acquisition unit.

2. The information processing device according to claim 1,
wherein the provision unit
outputs the information regarding the song selection reason by voice.

3. The information processing device according to claim 2,
wherein the constraint information defines at least one of a position or a length of time as the constraint, and
the provision unit
provides information regarding the song selection reason that can be output by voice on a basis of at least one of a position or a length of time indicated as a constraint in the constraint information.

4. The information processing device according to claim 3,
wherein the provision unit
selects the information regarding the song selection reason that can be output by voice on a basis of at least one of the position or the length of time indicated as the constraint from a plurality of pieces of information regarding the song selection reason which has different lengths and is prepared in advance.

5. The information processing device according to claim 3,
wherein the provision unit
generates the information regarding the song selection reason that can be output by voice on a basis of at least one of the position or the length of time indicated as the constraint in the constraint information.

6. The information processing device according to claim 3,
wherein the acquisition unit
acquires, as the constraint information for the song, at least one of a position or a length of time of a superimposable portion over which the information regarding the song selection reason that has been converted into voice can be superimposed when the song is reproduced by analyzing a structure of the song, and
the provision unit
provides the information regarding the song selection reason that can be output by voice on a basis of at least one of the position or the length of time of the superimposable portion.

7. The information processing device according to claim 1,
wherein the provision unit
displays and outputs the information regarding the song selection reason on a display unit.

8. The information processing device according to claim 7,
wherein the constraint information defines a display size of the display unit as the constraint, and
the provision unit
provides information regarding the song selection reason that can be output by display in accordance with the display size indicated as the constraint in the constraint information.

9. The information processing device according to claim 8,
wherein the provision unit
selects the information regarding the song selection reason that can be output by display in accordance with the display size indicated as the constraint from a plurality of pieces of information regarding the song selection reason which has different display sizes and is prepared in advance.

10. The information processing device according to claim 9,
wherein the provision unit
generates the information regarding the song selection reason that can be output by display in accordance with the display size indicated as the constraint.

11. The information processing device according to claim 1,
wherein, in a case where the information regarding the song selection reason including a plurality of song selection reasons does not satisfy the constraint, the provision unit
selects the information regarding the song selection reason on a basis of an importance of the song selection reason that has been set in advance.

12. The information processing device according to claim 11,
wherein the provision unit
preferentially selects information regarding the song selection reason including a song selection reason of a highest importance among the plurality of song selection reasons.

13. The information processing device according to claim 12,
wherein, in a case where the plurality of song selection reasons does not include a song selection reason of the highest importance, the provision unit
preferentially selects information regarding the song selection reason including a song selection reason having a second highest importance following the song selection reason of the highest importance.

14. The information processing device according to claim 6, further comprising:
a detection unit that detects information regarding a user;
a detection result analyzing unit that analyzes a detection result by the detection unit; and
a selection unit that selects a song selection algorithm for searching and acquiring a song depending on an analysis result by the detection result analyzing unit.

15. The information processing device according to claim 14,
wherein the provision unit
acquires the analysis result of the detection result analyzing unit,
decides whether or not there has been a change in the analysis result that is a basis of the song selection reason between timing when the song selection reason has been determined and timing when the information regarding the song selection reason is provided, and,
in a case where it is decided that there has been a change in the analysis result, changes a content of the information regarding the song selection reason depending on the analysis result.

16. The information processing device according to claim 15,
wherein, in a case where the provision unit decides that there has been a change in the analysis result that is a basis of the song selection reason, the provision unit
determines to change and to thereby provide an expression of the information regarding the song selection reason on a condition that the importance of the song selection reason is high.

17. The information processing device according to claim 15,
wherein, in a case where it is decided that there has been a change in the analysis result that is a basis of the song selection reason, the provision unit
determines not to provide the song selection reason on a condition that the importance of the song selection reason is not high.

18. An information processing method, by a computer, comprising:
acquiring constraint information indicating a constraint based on an output format of information; and
providing information regarding a song selection reason of a song output in the output format on a basis of the constraint information that has been acquired.
